(19) United States
(12) Patent Application Publication
(10) Pub. No.: US 2008/0271001 A1
(43) Pub. Date: Oct. 30, 2008

(54) METHOD OF GENERATING PROGRAM, INFORMATION PROCESSING DEVICE AND MICROCOMPUTER

(76) Inventors: Yo Nonomura, Tokyo (JP); Shunsuke Ota, Kokubunji (JP); Takashi Endo, Musashimurayama (JP); Takashi Tsukamoto, Tokorozawa (JP); Ichiro Kyushima, Yokohama (JP); Hiromi Nagayama, Akishima (JP); Kenichi Hirane, Kodaira (JP); Yoshiyuki Amanuma, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/853,058

(22) Filed: Sep. 11, 2007

(30) Foreign Application Priority Data
Sep. 11, 2006 (JP) 2006-245821
Feb. 7, 2007 (JP) 2007-027989
May 31, 2007 (JP) 2007-144454
Sep. 6, 2007 (JP) 2007-231299

(51) Int. Cl. G06F 9/45

(52) U.S. Cl. 717/143; 717/140

(57) ABSTRACT

In programming in high-level language, a method of generating a program supporting external specifications for generating secure codes having high tamper-resistance and automatically generating an executable program having tamper-resistance with regard to a portion designated by a user is provided. A syntax analysis step, an intermediate representation generation step, a register allocation step, an optimization processing step, an assembly language generation step, a machine language generation step and a machine language program linkage step are executed. And between finish of reading of the source program and generating the executable program, a tamper-resistant code insertion step of automatically generating a code having tamper-resistance coping with unjust analysis of an operation content of the executable program is executed to the source program, the intermediate representation, the assembly language program or the machine language program based on an instruction of a user.

### CROSS-REFERENCE TO RELATED APPLICATION

The present application claims priority from Japanese Patent Applications No. JP 2006-245821 filed on Sep. 11, 2006, No. JP 2007-027989 filed on Feb. 7, 2007, No. JP 2007-144454 filed on May 31, 2007, and No. JP 2007-231299 filed on Sep. 6, 2007, the contents of which are hereby incorporated by reference into this application.

### TECHNICAL FIELD OF THE INVENTION

The present invention relates to a method of generating a program loaded in a microcomputer for security application implemented in an IC card and the like, particularly, to a method of generating a program having a means to counteract unjust estimation and analysis of an operation content including an attack (a fault based attack) executing destruction of data and presumption of confidential information by causing unjust operation by inducing malfunction, an unjust register value or falsification of memory value using an electromagnetic wave, a radiation ray, excess voltage or other means, that is, tamper-resistance, an information processing device generating the program, and a microcomputer for security application having the program loaded therein.

### BACKGROUND OF THE INVENTION

An IC card is an information processing device of card type in which a semiconductor integrated circuit chip is embedded in a plastic card and a program and confidential data are sealed. For the IC card, transfer or writing of data is performed according to an instruction from a reader-writer, and most of handled data is highly confidential information such as personal information and electronic money and the like. And therefore, the IC card has a function protecting information therein from being rewritten without permission, exchanging information by data encryption and decryption processings using an cryptographic key or the like in order to prevent a third party from unjustly referring to confidential information.

Because of aforementioned application, in a microcomputer for IC card application, resistance against unjust reading of inside confidential information and analyze of an operation content (tamper-resistance) is an important point as its performance indicator. This tamper-resistance can be improved not only by improvements of device, but also by innovation to software implemented therein.

In an IC card handling confidential information, data exchanged with a reader-writer is encrypted. And therefore, conventionally, it has been considered that a difficulty level of analyzing confidential information in the IC card is the same as that of analyzing encryption algorithm. However, nowadays it has been pointed out that there is a risk that by observing consumption current at operation of the IC card, an operation content of software can be estimated and analyzed. This means that, in other words, a risk that “an actual processing content of the encryption processing can be analyzed” exists and it is considered to be achieved more easily than “analyzing encryption algorithm”.

Further, for unjust analyze of operation of the microcomputer for IC card applications, there is a method of estimating and analyzing a content of software operation by causing operation of an unjust route different from an original program flow aggressively by changing an instruction code of the program unjustly by making a content of a RAM and a register unjust by applying stresses such as abnormal voltage, abnormal clock, heat, light radiation and the like to the microcomputer (a fault based attack).

Furthermore, there has been developed an attack method of estimating cryptographic key information by causing a calculation error in a chip by this fault based attack and using difference between a correct calculation result and the wrong calculation result. A feature of this attack method is that time required for the attack is very short. For example, in the fault based attack method for RSA encryption using CRT calculation method, irrespective of key length, if only a calculation error of one time is obtained, a secret prime factor can be obtained from the greatest common divisor of difference between a correct value and the wrong value and modulo N of a public key. And a secret key can be presumed from the result.

In DES encryption widely used as a secret key encryption system, it has been reported by E. Biham and et. al. that if several or several ten pieces of correct calculation results and wrong calculation results are obtained, the secret key can be obtained. Also in AES encryption proposed as a subsequent encryption of the DES encryption, a method in which if a wrong calculation is made in one byte on the way of calculation, the key can be obtained from the wrong calculation results of two times has been proposed by J. J. Quisquater and et. al. These attacks have a feature that a calculation amount necessary for the attack is constant irrespective of length of the cryptographic key, or proportional with only bit length of the cryptographic key, and the calculation amount is very small.

As countermeasures against the fault based attack presuming the cryptographic key, following methods are proposed, according to encryption, (1) a method in which calculation is carried out for two times by duplicating the processing and it is confirmed that the calculation results of two times are equal, (2) a method in which recalculation by reverse calculation is carried out, (3) a calculation consistency check using a degeneration expression on residue field, parity, and the like.

### SUMMARY OF THE INVENTION

In order to cope with a such method of analyzing operation unjustly, in a case of trying to improve the tamper-resistance by innovation of software, in a software developing tool according to conventional art, it is necessary for a user himself to manually describe a secure program to improve the tamper-resistance as disclosed in Japanese Patent Application Laid-Open Publication No. 2002-334317 (Patent Document 1). However, a portion that the user can describe in a program is limited, and, it is difficult to completely control machine language generated by the developing tool, and therefore, it is difficult to actually generate a secure program manually.

On the other hand, as a method for avoiding an attack from an attacker by innovation of a compiler and a software implementing method, in particular by innovation of data area used in a program, a method in which a position of embedding dummy data is set into executable binary data disclosed in Japanese Patent Application Laid-Open Publication No. 2001-202237 (Patent Document 2), and a method in which resistance against program destructive attacks is improved by changing a stuck structure for each program disclosed in Japanese Patent Application Laid-Open Publication No. 2003-330563 (Patent Document 3) and the like have been proposed.

Note that, hereinafter, whole developing tools (including compiler, linkage editor and the like) for generating a final executable program described in machine language using a source program described by a user as input are referred to as a language tool.

As described previously, it is difficult for a user to generate a program having tamper-resistance. The reasons for this include a fact that in recent years, programs are often developed by high-level language such as C language and the like, and it is not realistic for a user to directly generate a source program of assembly language, and the like. Further, to manually develop a program with tamper-resistance requires many man-hours in comparison with ordinary software development.

Even if a source program having tamper-resistance is described by high-level languages such as C language, in an optimization processing of language tool increasing execution performance without changing an operation content and reducing size of an executable program, there is a possibility that description described above may be deleted as a redundant instruction. And, there is a possibility that a redundant instruction not relevant directly to increase the tamper-resistance is generated. In description by high-level language, it is in general difficult to control an actual instruction sequence in detail. Furthermore, even if a user generates a program having tamper-resistance, in order to verify effect thereof, it is necessary to execute the fault based attack actually, and it is difficult to realize.

Moreover, other reason is that a user is not always well versed in how to generate a program having tamper-resistance. To generate a program with tamper-resistance, a user must know, in addition to various programming technique to improve the tamper-resistance, specification and a characteristic of machine language instruction of objective machine. But in a case of programming by high-level language, this cannot be asked for in general.

And therefore, an object of the present invention is to provide a method of generating a program supporting external specification (an option, extended language specification or the like) for generating secure code having high tamper-resistance and generating automatically a secure executable program having tamper-resistance for a portion designated by a user through interface in programming by high-level language such as C language and the like.

The above and other objects and novel characteristics of the present invention will be apparent from the description of this specification and the accompanying drawings.

The typical ones of the inventions disclosed in this application will be briefly described as follows.

The present invention provides a method of generating a program making an executable program by reading a source program described in programming language by a computer. The computer executes: a syntax analysis step of reading the source program and performing syntax analysis; an intermediate representation generation step of generating an intermediate representation from the source program; a register allocation step of allocating a register to the intermediate representation; an optimization process step of performing an optimization processing to the intermediate representation; an assembly language generation step of generating an assembly language program from the intermediate language; a machine language generation step of generating a machine language program from the assembly language program; and a machine language program linkage step of linking the machine language program and another machine language program and generating an executable program. And tamper-resistant code insertion step of automatically generating a code having tamper-resistance to cope with unjust analysis of an operation content of the executable program is executed to the source program, the intermediate language, the assembly language program, or the machine language program based on an instruction of a user, between reading the source program and generating the executable program.

Further, the present invention can be applied also to an information processing device executing the method of generating a program and a microcomputer storing an executable program generated by the method of generating a program.

The effects obtained by typical aspects of the present invention will be briefly described below.

According to the present invention, a secure executable program having tamper-resistance that is hardly generated manually by a user can be generated automatically by a language tool. And therefore, development productivity of a secure program is improved.

### BRIEF DESCRIPTIONS OF THE DRAWINGS

FIG. 1 is a configuration diagram showing an example of an information processing device on which a language tool according to a first embodiment of the present invention operates;

FIG. 2 is a diagram showing an example of structure and a processing outline of the language tool according to the first embodiment of the present invention;

FIG. 3 is a configuration diagram showing an example of a target microcomputer in which an executable program generated by the language tool according to the first embodiment of the present invention operates;

FIG. 4 is a flow chart showing a flow of a processing in a compiler according to the first embodiment of the present invention;

FIG. 5 is an example of a source program inputted to the compiler according to the first embodiment of the present invention;

FIG. 6 is a diagram showing an example of an intermediate representation generated by the compiler according to the first embodiment of the present invention before executing a tamper-resistant code insertion processing;

FIG. 7 is a flow chart showing a detailed example of the tamper-resistant code insertion processing in the compiler according to the first embodiment of the present invention;

FIG. 8 is a diagram showing an example of the intermediate representation after executing the tamper-resistant code insertion processing by the compiler according to the first embodiment of the present invention;

FIG. 9 is a diagram showing an example of an assembly language program outputted by a compiler according to conventional art;

FIG. 10 is a diagram showing an example of an assembly language program outputted by the compiler according to the first embodiment of the present invention;

FIG. 11 is a diagram showing an example of designating a function inserting tamper-resistant code in the compiler according to the first embodiment of the present invention by a compile option;

FIG. 12 is a diagram showing an example of designating insertion of tamper-resistant code in more detailed degree in the compiler according to the first embodiment according of the present invention;

FIG. 13 is an example of a source program inputted to a compiler according to a second embodiment of the present invention;

FIG. 14 is a diagram showing an example of an intermediate representation generated by the compiler according to the second embodiment of the present invention before executing a tamper-resistant code insertion processing;

FIG. 15 is a flow chart showing a detailed example of the tamper-resistant code insertion processing in the compiler according to the second embodiment of the present invention;

FIG. 16 is a diagram showing an example of the intermediate representation after executing the tamper-resistant code insertion processing by the compiler according to the second embodiment of the present invention;

FIG. 17 is a diagram showing an example of an assembly language program outputted by the compiler according to the conventional art;

FIG. 18 is a diagram showing an example of an assembly language program outputted by the compiler according to the second embodiment of the present invention;

FIG. 19 is a diagram showing an example of generating a code executing a conditional branch continuously without inverting a branch condition in the compiler according to the second embodiment of the present invention;

FIG. 20 is a diagram showing an example of an assembly language program outputted in a case where a processing inserting a code executing branch route verification of the multiple conditional branch in the first embodiment is further combined in the compiler according to the second embodiment of the present invention;

FIG. 21 is an example of a source program inputted to a compiler according to a third embodiment of the present invention;

FIG. 22 is a diagram showing an example of an intermediate representation generated by the compiler according to the third embodiment of the present invention before executing a tamper-resistant code insertion processing;

FIG. 23 is a flow chart showing a detailed example of the tamper-resistant code insertion processing in the compiler according to the third embodiment of the present invention;

FIG. 24 is a diagram showing an example of the intermediate representation after executing the tamper-resistant code insertion processing by the compiler according to the third embodiment of the present invention;

FIG. 25 is a diagram showing an example of an assembly language program outputted by the compiler according to the conventional art;

FIG. 26 is a diagram showing an example of an assembly language program outputted by the compiler according to the third embodiment of the present invention;

FIG. 27 is a diagram showing an example of a source program of C language in which a loop processing is described;

FIG. 28 is a diagram showing an example of a result of compiling the source program in FIG. 27 by a conventional language tool described by assembler description;

FIG. 29 is a diagram showing an example of processing order in a case of executing a program in FIG. 28;

FIG. 30 is a diagram showing an example of a result of compiling the source program in FIG. 27 with a loop processing complicated described by assembler description;

FIG. 31 is a diagram showing an example of processing order in a case of executing a program in FIG. 30;

FIG. 32 is a diagram showing an example of generating a code in a case of expanding a loop processing into an instruction sequence of plural patterns by a language tool according to a fourth embodiment of the present invention;

FIG. 33 is a diagram showing an example of a format by extended language specification in a case of describing a source program in the language tool according to the fourth embodiment of the present invention;

FIG. 34 is a diagram showing an example of a case in which the loop processing is complicated by updating a judgment value using a table of judgment value or something equivalent thereto, in the language tool according to the fourth embodiment of the present invention;

FIG. 35 is a diagram showing an example of a case in which the loop processing is complicated by updating the judgment value using a value set in register, in the language tool according to the fourth embodiment of the present invention;

FIG. 36 is a diagram showing an example of a source program of C language describing a conditional branch processing;

FIG. 37 is a diagram showing an example of a result of compiling the source program in FIG. 36 by the conventional language tool described by assembler description;

FIG. 38 is a diagram showing an example of a source program describing a conditional branch processing by C language, an example of a result of compiling the source program by the conventional compiler, and an example of a result of compiling the source program by a compiler according to a fifth embodiment of the present invention;

FIG. 39 is a diagram showing an example of a format by extended language specification in a case of describing a source program in a language tool according to the fifth embodiment of the present invention;

FIG. 40 is a diagram showing an example of a source program describing an if-sentence not having an else-clause, an example of a result of compiling the source program by the conventional compiler, and an example of a result of compiling the source program by the compiler according to the fifth embodiment of the present invention;

FIG. 41 is a diagram showing an example of a source program describing instruction for executing check sum verification, and an example of a result of compiling the source program by a compiler according to a sixth embodiment of the present invention;

FIG. 42 is a diagram showing an example of a format by extended language specification in a case of describing a source program in a language tool according to the sixth embodiment of the present invention;

FIG. 43 is a diagram showing an example of a source program designating a range crossing conditional branches, and an example of a result of compiling the source program;

FIG. 44 is a diagram showing an example of a source program designating a range crossing conditional branches, and an example of a result of compiling the source program by the compiler according to a sixth embodiment of the present invention;

FIG. 45 is a diagram showing an example of structure and process outline of a language tool according to a seventh embodiment of the present invention;

FIG. 46 is a diagram showing an example of a processing flow in a general source program;

FIG. 47 is a diagram showing an example of a processing flow in an executable program obtained by the language tool according to the seventh embodiment of the present invention;

FIG. 48 is a diagram showing a concrete example of a duplication processing in the seventh embodiment of the present invention;

FIG. 49 is a diagram for explaining depth of dependence analysis in the seventh embodiment of the present invention; and

FIG. 50 is a configuration diagram showing an example of a target microcomputer in which an executable program according to the eighth embodiment of the present invention operates.

### DESCRIPTIONS OF THE PREFERRED EMBODIMENTS

Hereinafter, embodiments of the present invention will be described in detail with reference to the accompanying drawings. Note that the same components are denoted by the same reference symbols throughout the drawings for describing the embodiment, and the repetitive description thereof will be omitted.

### <General Outline>

Hereinafter, a language tool as an embodiment according to the present invention is explained. The language tool as the present embodiment includes external specification for generating machine language having tamper-resistance (extended language specification, an option or the like) and provides an interface which can easily generate a program having tamper-resistance.

The language tool according to the present embodiment executes a tamper-resistant code insertion step for generating a machine language improving tamper-resistance without changing an operation content thereof, to a portion in a source program designated by a user through the interface. The codes improving tamper-resistance generated at this tamper-resistant code insertion step are the following six kinds.

(1) Branch Route Verification of Multiple Condition Branch

In a case where contents of information register for a conditional branch and the like become unjust by a fault based attack, there is a risk of execution of an unjust route. In a case of a multiple conditional branch in which a conditional branch makes nest, information to check whether or not a judgment processing at each conditional branch is passed correctly is held on a register or a memory, and execution of an unjust branch route is prevented by checking the information whether or not it is an appropriate value in a processing block of each conditional branch destination.

(2) Multiplexing of Condition Branch Judgment

In a case where contents of information register for conditional branch and the like become unjust by a fault based attack, there is a risk of execution of an unjust route. And therefore, the judgment processing at a conditional branch is carried out not singly, but doubly or triply, and thereby branch to a right route is carried out more precisely, and the risk of an unjust branch route execution is restrained.

(3) Parameter Contents Check at Function Call

In a case where RAM (a stuck at execution) transits to an unjust state by a fault based attack, parameters (augments) of a function call become unjust, and there is a risk that unjust operation is executed. And therefore, at the function call, a total value (check sum) of parameters and the like are set on a memory or a register at a calling side, and a total value of received parameters is calculated at a called side, and compares it with the total value set by the calling side and performs a validity check of parameters between the calling side and the called side, and thereby unjust execution of a function is prevented.

(4) Dilution of Current Characteristic at Execution

Machine language diluting a feature of a current characteristic at execution without changing an operation content of a program is generated. And thereby, it becomes difficult to analyze the operation content of the program generated by the language tool according to the present embodiment from consumption current, and the risk of confidential information held in an IC card or the like being known can be suppressed. As a method of diluting the feature of a current characteristic at execution, there are two methods, that is, (a) complication of the current characteristic by code generation of plural patterns for a loop processing, and (b) approximation of the current characteristic by equalizing execution time of respective branch routes of conditional branch.

(5) Check Sum Calculation and Verification

Machine language enabling monitoring of normal execution of a program flow by calculating an expected value of check sum made by accumulating instruction codes, and comparing it with an accumulated value of instruction codes at execution is generated. And thereby, it becomes difficult to analyze a program generated by the language tool according to the present embodiment by a fault based attack causing unjust operation, and the risk of confidential information held in an IC card or the like being known can be suppressed.

(6) Duplication Processing of Program Code

As a countermeasure against the fault based attack, in a method of detecting an operation error of a program by using a duplication processing, in particular as a method not using a hardware configuration duplicating an operation system of a program, and realized on hardware on an assumption of an existing single processing system, calculations are carried out two times by duplicating a program code, and an operation error of the program is detected by confirming that the calculation results of two times are equal.

Hereinafter, examples of language tools to which these six kinds of methods are applied are explained.

### First Embodiment

Hereinafter, as a first embodiment according to the present invention, an example of a language tool generating an executable program performing branch route verification of multiple conditional branch is explained.

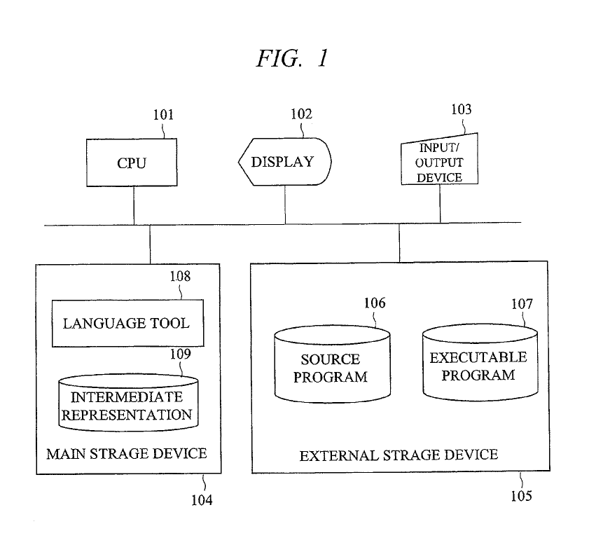

FIG. 1 is a configuration diagram showing an example of an information processing device on which a language tool according to the present embodiment operates. As shown in FIG. 1, the information processing device is composed of a CPU 101, a display 102, an input/output device 103, a main storage device 104, and an external storage device 105. In the main storage device 104, a language tool 108 according the present embodiment and an intermediate representation 109 generated in a compile processing by the language tool 108 are stored. In the external storage device 105, a source program 106 to become input to the language tool 108 and an executable program 107 generated by the language tool 108 are stored. The compile processing is performed by executing the language tool 108 by the CPU 101. The display 102 informs a user of a compile processing status and the like by displaying the same. The input/output device 103 is used for giving commands from the user to the language tool 108.

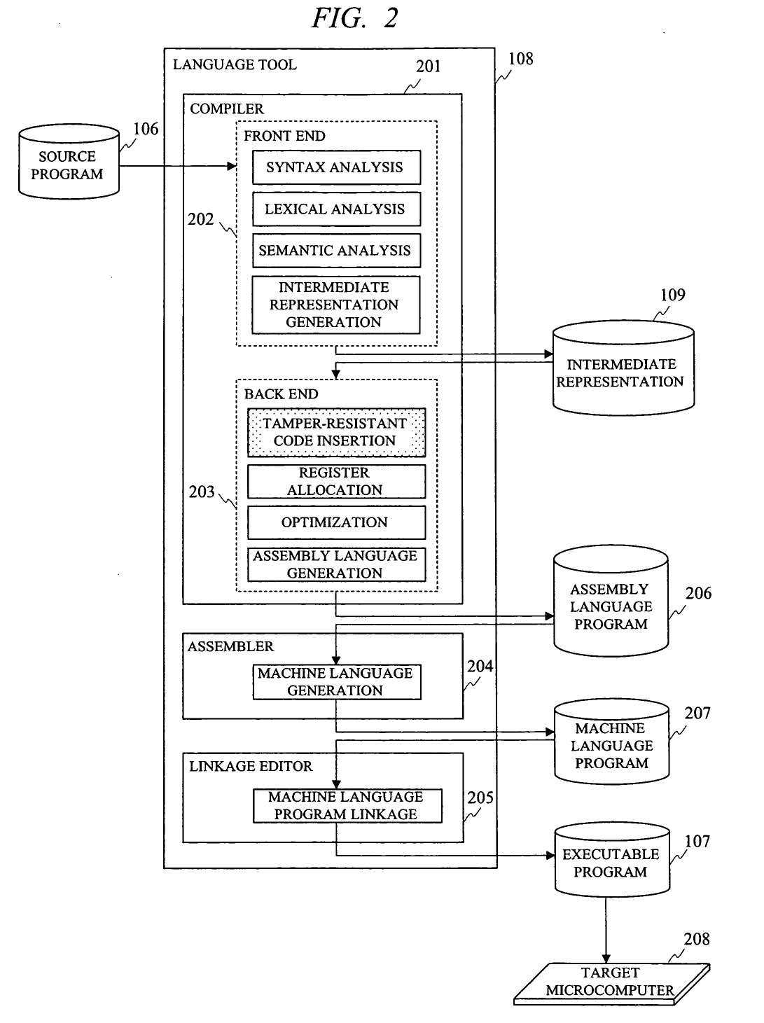

Hereinafter, concrete contents of the language tool in the present embodiment are explained. FIG. 2 is a diagram showing an example of structure and a processing outline of the language tool according to the present embodiment. In FIG. 2, the language tool 108 is composed of a compiler 201, an assembler 204, and a linkage editor 205, and the compiler 201 is divided into a front end 202 and a back end 203.

The language tool 108 operates on the information processing device shown in FIG. 1. First, the compiler 201 reads the source program 106 described in high-level language such as C language and the like. The compiler 201 performs a processing of syntax analysis, lexical analysis, and semantic analysis on the read source program 106 by the front end 202, and generates the intermediate representation 109. The intermediate representation 109 is compiler inside data necessary in the compile processing.

Next, the compiler 201 performs a tamper-resistant code insertion processing by the back end 203, and adds and generates a secure instruction sequence improving the tamper-resistance to the intermediate representation 109. Then, a register allocation processing and an optimization processing are performed based on the intermediate representation 109, and an assembly language program 206 is generated. And thereby, the assembly language program 206 is generated in the form including the secure instruction sequence improving the tamper-resistance.

Then, the assembler 204 reads the assembly language program 206 generated by the compiler 201 and generates a machine language program 207. And thereafter, the linkage editor 205 links other machine language program to the machine language program 207, and thereby the executable program 107 is generated. The executable program 107 generated by the language tool 108 in this manner is stored in and executed by a target microcomputer 208 such as an IC card and the like.

Note that, the tamper-resistant code insertion processing is carried out to the intermediate representation 109 after the intermediate representation generation processing in the language tool 108 according to the present embodiment, and in a case where it is carried out to the intermediate representation 109, it has only to be carried out before the assembly language generation processing, and it can be carried out after the optimization processing. Further, the assembler 204 or the linkage editor 205 can carry out the tamper-resistant code insertion processing not to the intermediate representation 109 but to the assembly language program 206 or the machine language program 207. Furthermore, if possible, the tamper-resistant code insertion processing can be carried out to the source program 106 by a preprocessor not illustrated, and then the processing by the compiler 201 can be carried out.

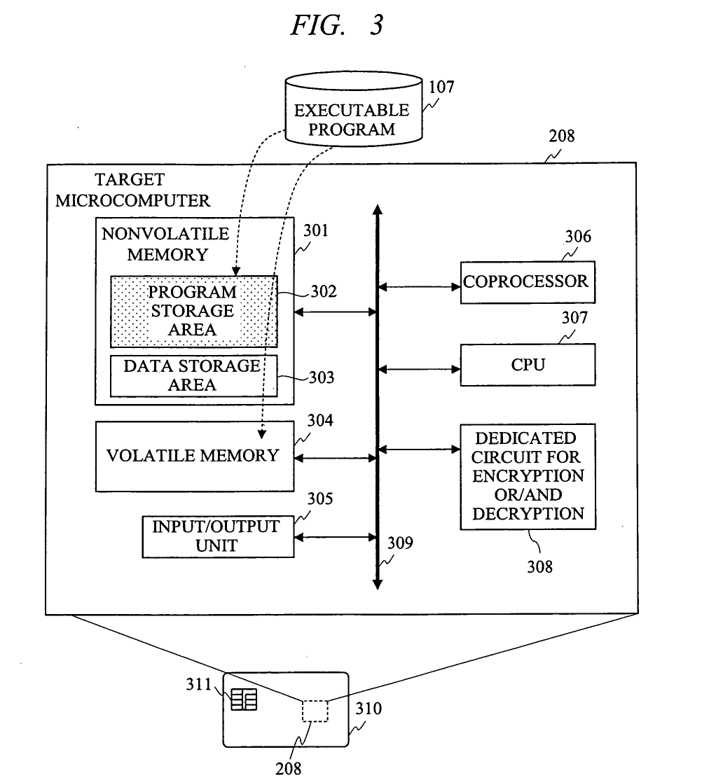

FIG. 3 is a configuration diagram showing an example of the target microcomputer 208 in which the executable program 107 generated by the language tool 108 according to the present embodiment is executed. The target microcomputer 208 is, although not limited specifically, a microcomputer mainly for IC card applications formed on one semiconductor substrate such as a single crystal silicon substrate and the like by known semiconductor integrated circuit manufacture technology, and is composed of a nonvolatile memory 301, a volatile memory 304, an input/output unit 305, a coprocessor 306, a CPU 307, a dedicated circuit for encryption or/and decryption 308, and a bus 309 for connecting them.

The nonvolatile memory 301 is, although not limited specifically, composed of a flash memory and the like, and in a program storage area 302 in the nonvolatile memory 301, the executable program 107 generated by the language tool 108 is stored. This executable program 107 is executed by the CPU 307. And, in the data storage area 303, data such as cryptographic key data, confidential information and the like is stored.

The volatile memory 304 is used as a variable storage area in a calculation processing in the CPU 307 and a storage area of intermediate data. In the dedicated circuit for encryption or/and decryption 308, an encryption processing for avoiding unjust use of the IC card 310 with the target microcomputer 208 mounted thereon is performed.

Here, for example, in the program storage area 302, besides the executable program 107 including the secure instruction sequence added and generated by the tamper-resistant code insertion processing, a second executable program 107 generated by setting the tamper-resistant code insertion processing invalid and not including a secure instruction sequence can be stored, if necessary.

Setting validity or invalidity of the tamper-resistant code insertion processing can be controlled by setting an arbitrary register when the source program 106 is read by the language tool 108. And thereby, for the program requiring tamper-resistance, the tamper-resistant code insertion processing can carried out to improve the tamper-resistance, and for other programs, executable programs 107 with restrained program capacity can be generated, and therefore, unnecessary increase of program capacity can be suppressed.

Further, structure in which the executable program 107 is loaded from outside of the IC card 310 to the volatile memory 304 via an external terminal 311, and executed by the CPU 307 can be employed. The volatile memory 304 may be a dynamic random access memory (DRAM), or a static random access memory (SRAM). In such structure, the same effect as in a case of the structure in which the executable program 107 is stored in the nonvolatile memory 301 can be obtained.

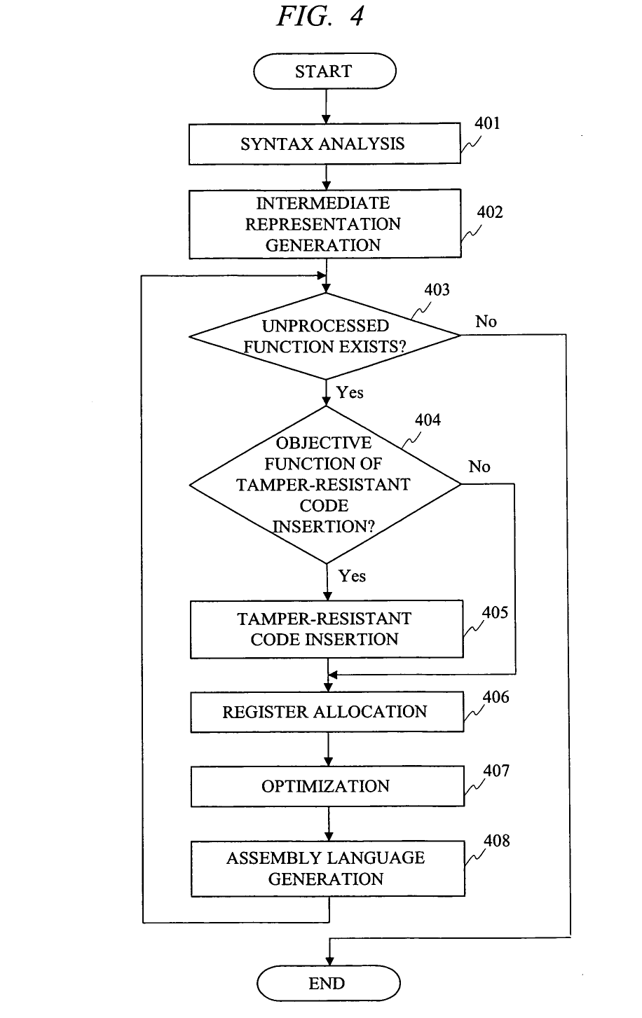

FIG. 4 is a flow chart showing an example of a flow of a processing in the compiler 201 according to the present embodiment. First, at step 401, the source program 106 is read by the front end 202 and the syntax analysis is carried out. As for the syntax analysis processing, descriptions are found in, for example, Aho, Alfred V.; Sethi, Ravi; Ullman, Jeffrey D. “Compilers” SAIENSU-SHA, 1990, pp. 30 to 74, and the like, and therefore, detailed explanations are omitted herein. Next, at step 402, the intermediate representation is generated by the front end 202. As for the intermediate language, descriptions are also found in, for example, Aho, Alfred V.; Sethi, Ravi; Ullman, Jeffrey D. “Compilers” SAIENSU-SHA, 1990, pp. 564 to 617 and the like, and therefore, detailed explanations are omitted herein.

Next, at step 403, it is checked that whether or not an unprocessed function exists. In C language, since the input source program is divided into processing units called functions, in the language tool 108 of the present embodiment, it is supposed that a translation processing is carried out for each function. If there is not an unprocessed function, the procedure ends here. If there is an unprocessed function, the unprocessed function is taken out at step 404, and it is checked whether or not the function is a function of an objective of tamper-resistant code insertion. The check whether or not it is a function of the objective of the tamper-resistant code insertion is performed by, for example, recording information (ON/OFF) to a table created for the respective input functions in the intermediate representation 109, and referring to the information. The information is to be set to a function which is designated to be subjected to the tamper-resistant code insertion by language specification expansion which is described later in the source program 106, at the syntax analysis of the step 401.

In a case where the function is the objective of the tamper-resistant code insertion, the procedure transits to step 405, and a tamper-resistant code insertion processing is carried out to the intermediate representation 109 at the back end 203, and then, the procedure transits to step 406. Details of the tamper-resistant code insertion processing at the step 405 are described later. In a case where the function is not the objective of the tamper-resistant code insertion, the procedure transits to step 406. Note that, as described above, the tamper-resistant code insertion processing at the step 405 can be carried out after an optimization processing at step 407.

At the step 406, register allocation is carried out to the intermediate representation 109 at the back end 203. As for the register allocation processing, descriptions are found in Aho, Alfred V.; Sethi, Ravi; Ullman, Jeffrey D. “Compilers II” SAIENSU-SHA, 1990, pp. 659 to 665 and the like, and therefore, detailed explanations are omitted herein. Next, the procedure transits to step 407, and the optimization processing is carried out to the intermediate representation 109 at the back end 203. As for the optimization processing, descriptions are also found in Aho, Alfred V.; Sethi, Ravi; Ullman, Jeffrey D. “Compilers II” SAIENSU-SHA, 1990, pp. 715 to 881 and the like, and therefore, detailed explanations are omitted herein.

Next, the procedure transits to step 408, and assembly language is generated from the intermediate representation 109 at the back end 203, and the assembly language program 206 is outputted. As for the assembly language generation processing, descriptions are also found in Aho, Alfred V.; Sethi, Ravi; Ullman, Jeffrey D. “Compilers II” SAIENSU-SHA, 1990, pp. 679 to 692 and the like, and therefore, detailed explanations are omitted herein.

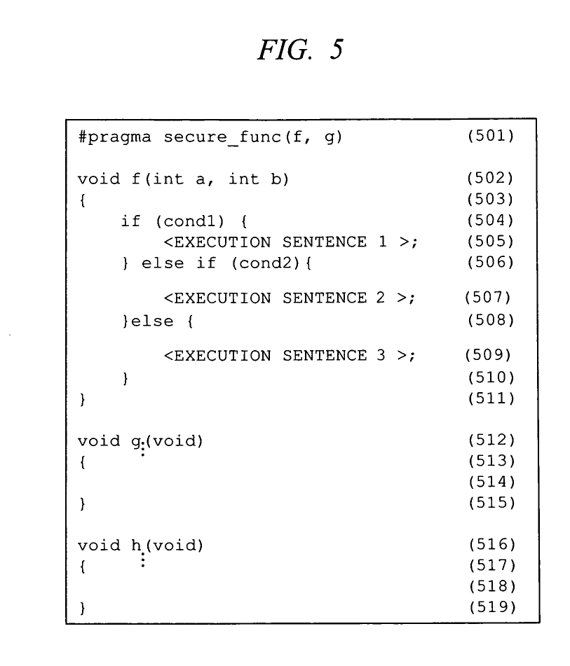

FIG. 5 shows an example of the source program 106 to be inputted to the compiler 201 in the present embodiment. In the present embodiment, the source program 106 is described in C language, and the language specification expansion for designating tamper-resistant code insertion objective is made. A description “#pragma secure_func (f, g)” shown in line 501 is that, and instructs to insert the tamper-resistant code to a function f in line 502 and a function g in line 512. For a function h in line 516 to which a designation is not made, normal code generation is carried out. The function f in line 502 means that, if a value of a condition equation cond1 in line 504 is true, “EXECUTION SENTENCE 1” in line 505 is performed, and if the value is false, if a value of a condition equation cond2 is true, “EXECUTION SENTENCE 2” in line 507 is performed, and if the value is false, “EXECUTION SENTENCE 3” in line 509 is performed.

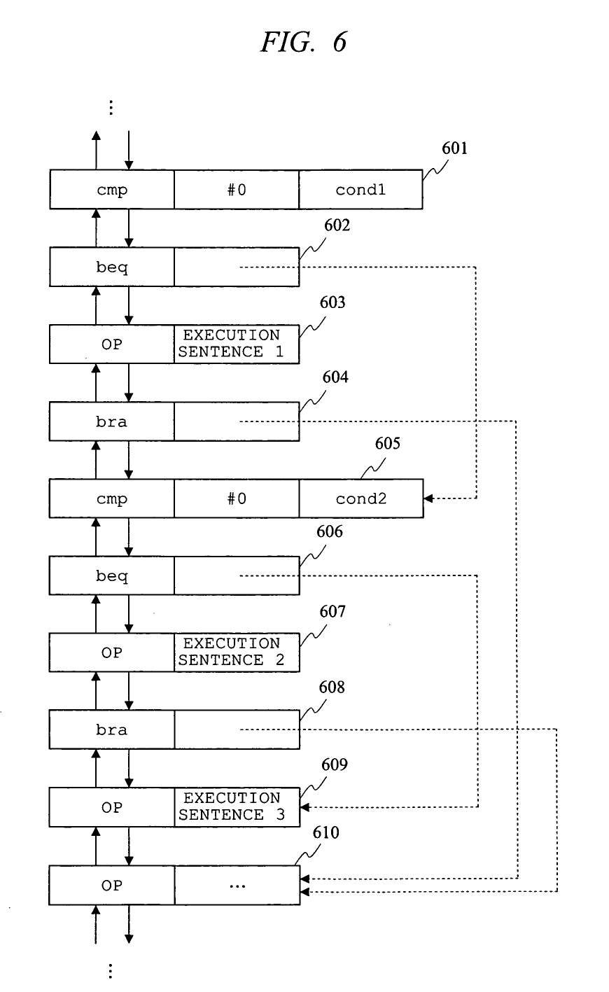

FIG. 6 shows an example of the intermediate representation 109 generated by the compiler 201 in the present embodiment, before the tamper-resistant code insertion processing at the step 405. The intermediate representation generated by the compiler includes in general a representation at a level near the source program to a representation at a level near the machine language. In the present embodiment, an intermediate representation at a level near the machine language is supposed. The intermediate representation 109 has structure in which memory cells called instruction are linked in a list form by dual link, and solid line arrows in the figure show links between instructions.

The intermediate representation 109 shown in FIG. 6 corresponds to a portion from line 504 to line 510 of the source program 106 shown in FIG. 5. An instruction 601 (cmp) means to compare between a constant 0 (false) and a variable cond1 (compare). An instruction 602 (beq) means, if a result of the comparison shows 0 and cond1 are equal (Equal), to branch to an instruction 605 designated (linked) by a pointer of operand. If it is not (not equal), the procedure transits to a next instruction 603 (fall-through). An instruction 603 is a sentence corresponding to the “EXECUTION SENTENCE 1” in line 505 in the source program 106 in FIG. 5. Although it is shown by one instruction here, there are cases in which it is composed of plural instructions. An instruction 604 (bra) means to unconditionally branch to an instruction 610 designated by a pointer of operand.

An instruction 605 (cmp) means to compare a constant 0 (false) and a variable cond2 (compare). An instruction 606 (beq) means, if a result of the comparison shows 0 and cond2 are equal (Equal), to branch to an instruction 609 designated (linked) by a pointer of operand. If it is not (not equal), the procedure transits to a next instruction 607 (fall-through). An instruction 607 is a sentence corresponding to the “EXECUTION SENTENCE 2” in line 507 in the source program 106 in FIG. 5. Although it is shown by one instruction here, there are cases in which it is composed of plural instructions. An instruction 608 (bra) means to unconditionally branch to an instruction 610 designated by a pointer of operand.

An instruction 609 is a sentence corresponding to the “EXECUTION SENTENCE 3” in line 509 in the source program 106 in FIG. 5. Although it is shown by one instruction here, there are cases in which it is composed of plural instructions. An instruction 610 is an instruction executed after completion of an if . . . else-if . . . else-clause in the source program 106 in FIG. 5.

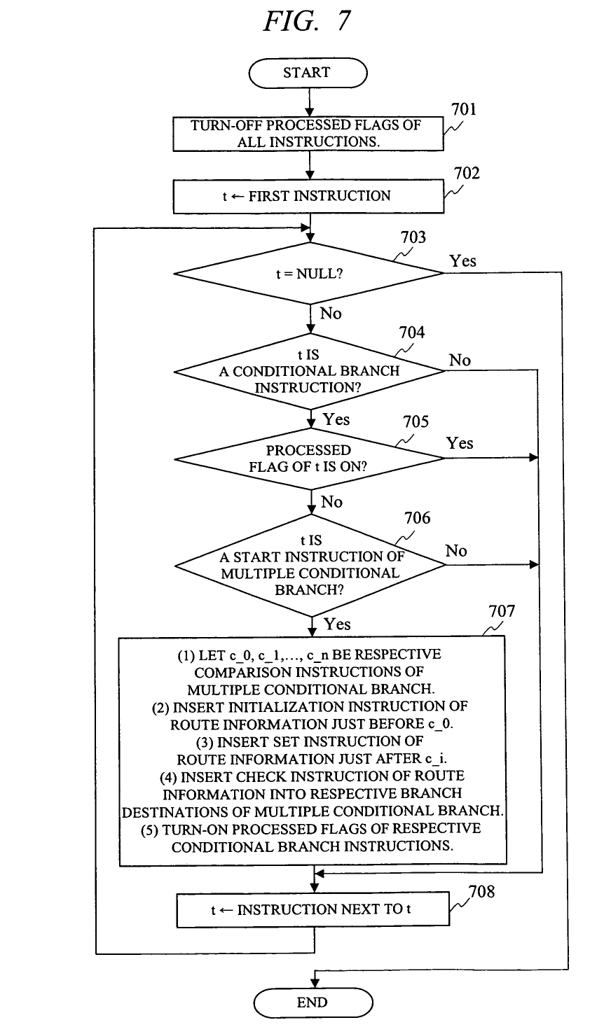

FIG. 7 is a flow chart showing a detailed example of the tamper-resistant code insertion processing at the step 405 in FIG. 4. First, at step 701, processed flags of all instructions in the intermediate representation 109 are turned OFF. Next, at step 702, a first instruction in the intermediate representation 109 is taken out, and it is set as t. Next, at step 703, it is checked whether or not t is NULL. If t is NULL, all instructions are already processed and the procedure ends. If t is not NULL, the procedure transits to step 704, and it is checked whether or not t is a conditional branch instruction. If t is not a conditional branch instruction, the procedure transits to step 708, and a next instruction of t is newly set as t, and the processing is repeated from the step 703. If t is a conditional branch instruction at the step 704, it is checked whether or not the processed flag of t is ON at the step 705. If it is ON, the procedure transits to step 708, and if it is not ON, the procedure transits to step 706.

At step 706, it is checked whether or not t is a start instruction of a multiple conditional branch. Whether or not t is the start instruction of the multiple conditional branch is determined by judging two matters: (1) an instruction just before t is a comparison instruction, (2) an end of an instruction sequence (a basic block) starting with an instruction at a destination of branch t and not including interflow or branch is a comparison instruction and a conditional branch instruction just after that. In a case in which a pattern of a comparison instruction and a conditional branch instruction follow in the branch destination, it is considered to belong to the same multiple conditional branch as long as it continues. By the above determination, if t is not a start instruction of multiple conditional branch, the procedure transits to step 708. If t is a start instruction of multiple conditional branch, the procedure transits to step 707.

At the step 707, the following processing (1) to (5) are carried out.

(1) Let c_{—}0, c_{—}1, . . . c_n be respective comparison instructions of the multiple conditional branch.

(2) Insert an initialization instruction of route information just before c_{—}0.

(3) Insert a set instruction of route information just after c_i.

(4) Insert a check instruction of route information into respective branch destinations of the multiple conditional branch.

(5) Turn-on processed flags of the respective conditional branch instructions in route of the multiple conditional branch and the conditional branch instruction in the check instruction inserted in the above (4).

After completion of the above processing (1) to (5), the procedure transits to step 708.

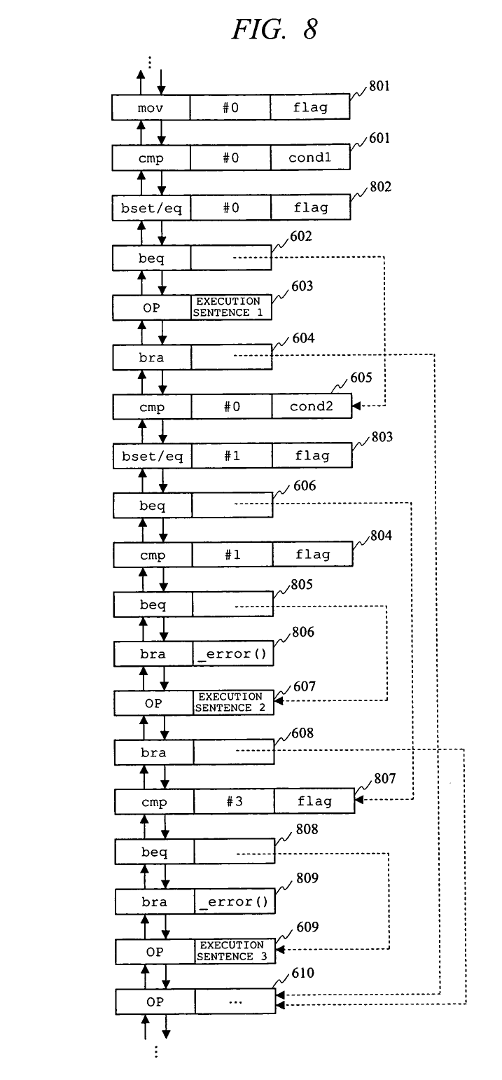

FIG. 8 shows an example of an intermediate representation 109 after the tamper-resistant code insertion processing shown in FIG. 7 is carried out to the intermediate representation 109 in FIG. 6. Hereinafter, a processing of generating the intermediate representation 109 according to the processing flow in FIG. 7 is shown.

At step 702, a first instruction (an instruction 601) is taken out from the intermediate representation 109 in FIG. 6, and it is set as t. At step 703, it is checked whether or not t is NULL. Since t is not NULL, the procedure transits to step 704, and it is checked whether or not t is a conditional branch instruction. Since t is not a conditional branch instruction, the procedure transits to step 708, and a next instruction of t (an instruction 602) is newly set as t. And again, at step 703, it is checked whether or not t is NULL, and since t is not NULL, the procedure transits to step 704, and it is checked whether or not t is a conditional branch instruction. Since t is a conditional branch instruction, the procedure transits to step 705, and it is checked whether or not processed flag is ON. Since the processed flag is OFF, the procedure transits to step 706, and it is checked whether or not t is a start instruction of the multiple conditional branch. Since (1) an instruction just before t (an instruction 601) is a comparison instruction, and (2) an instruction at a destination of branch t (an instruction 605) is a comparison instruction and an instruction just after thereof (an instruction 606) is a conditional branch instruction, it is determined that t is a start instruction of the multiple conditional branch, and the procedure transits to step 707.

At the step 707, the following processing (1) to (5) are carried out.

(1) Let c_{—}0, c_{—}1 be respective comparison instructions (an instruction 601, an instruction 605) of the multiple conditional branch.

(2) Insert an initialization instruction (an instruction 801) of route information just before c_{—}0. The instruction 801 (mov) means to move a constant 0 to a variable flag (Move).

(3) Insert set instructions (an instruction 802, an instruction 803) of route information recording that c_{—}0, c_{—}1 are passed to variable flag just after c_{—}0, c_{—}1. The instruction 802 and the instruction 803 (bset/eq) mean that if a result of comparison between c_{—}0 and c_{—}1 is equal, 1 is set to 0th and 1st bits of variable flag respectively.

(4) To the processing in destinations of respective branch of multiple conditional branch, insert instructions (an instruction 804, an instruction 807) to check whether or not 1 is set to the 0th bit of variable flag (a value of variable flag is 1) and whether or not 1 is set to the 0th and 1st bits (the value of variable flag is 3) by comparing with constant, conditional branch instructions (an instruction 805, an instruction 808) to branch to a normal processing if comparison results are equal, and branch instructions (an instruction 806, an instruction 809) to branch to an error processing unconditionally. The instruction 805 and the instruction 808 (beq) show respectively to branch to an instruction 607 and an instruction 609 designated (linked) by a pointer of operand, if comparison results of instruction 804 and instruction 807 are equal.

(5) Turn-on processed flags of respective conditional branch instructions (an instruction 602, an instruction 606) in route of multiple conditional branch and the respective conditional branch instructions (an instruction 805, an instruction 808) inserted in the above (4).

Next, the procedure transits to step 708, an instruction (an instruction 603) next to t is newly set as t, and the procedure goes back to step 703. And again, at step 703, it is checked whether or not t is NULL. Since t is not NULL, the procedure transits to step 704, and it is checked whether or not t is a conditional branch instruction. Since t is not a conditional branch instruction, the procedure transits to step 708, and an instruction next to t (an instruction 604) is newly set as t. At this time, since there is not an instruction that is a conditional branch instruction with processed flag being OFF in the intermediate representation 109 under the processing, the procedure does not transits to step 707 in following processing, and the tamper-resistant code insertion processing is not carried out.

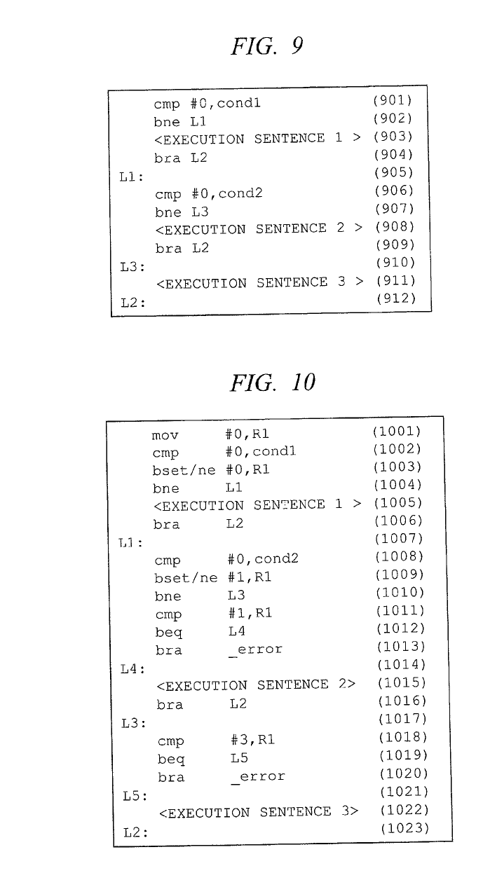

FIG. 9 shows an example of an assembly language program outputted by a compiler according to the conventional art when the source program 106 in FIG. 5 is inputted. First, by “cmp #0 cond1” instruction (an instruction 901), a value of constant 0 (false) and a value of cond1 are compared, and the result is stored in a condition code register. In a next “beq L1” instruction (an instruction 902), a value of the condition code registers is checked, and when the comparison result is equal (Equal), a branch is made to a label L1 (an instruction 905). When it is not (not equal), the procedure transits to an instruction just next, and EXECUTION SENTENCE 1 (an instruction 903) is executed, and at “bra L2” instruction (an instruction 904), a branch is made to a label L2 (an instruction 912).

In a case where branch is made to L1 by the instruction 902, by “cmp #0 cond2” instruction (an instruction 906), a value of constant 0 (false) and a value of the condition equation cond2 are compared, and the result is stored in a condition code register. In the next conditional branch instruction (an instruction 907), a value of the condition code registers is checked, and when the comparison result is equal, branch is made to a label L3 (an instruction 910). When it is not (not equal), the procedure transits to an instruction just next, and EXECUTION SENTENCE 2 (an instruction 908) is executed, and at an instruction 909, a branch is made to L2. In a case where a branch is made to L3 by an instruction 907, EXECUTION SENTENCE 3 (an instruction 911) is executed and the procedure transits to an instruction just next (same as a branch destination L2).

FIG. 10 shows an example of an assembly language program 206 outputted by the compiler 201 according to the present embodiment when the source program 106 in FIG. 5 is inputted. First, by a “mov #0, R1” instruction (an instruction 1001), a register R1 is initialized to 0. Next, just after a condition comparison instruction (an instruction 1002) corresponding to an if-sentence in line 504 of the source program 106 in FIG. 5, by a “bset/eq #0, R1” instruction (an instruction 1003), when a comparison result of the above condition comparison instruction is equal, 1 is set to a 0th bit of a register R1, and thereby passing the above if-sentence is recorded, and by a next conditional branch instruction 1004, a branch is made to a label L1 (an instruction 1007). When it is not (not equal), after the EXECUTION SENTENCE 1 (an instruction 1005) is executed, by a branch instruction (an instruction 1006), a branch is made to a label L2 (an instruction 1023), and the procedure gets out of the multiple conditional branch.

In a case where a branch is made to L1 by an instruction 1004, just after a condition comparison instruction (an instruction 1008) corresponding to an if-sentence in line 506 of the source program 106 in FIG. 5, when a comparison result of the above condition comparison instruction is equal, 1 is set to the 1st bit of the register R1 (an instruction 1009), thereby passing the above if-sentence is recorded.

In a case where a comparison result of the above condition comparison instruction of instruction 1008 is not equal, a branch is not made by a conditional branch instruction of instruction 1010 and the procedure transits to a condition comparison instruction of instruction 1011, and it is checked whether or not 1 is set to the 0th bit of the register R1 (the value of R1 is 1), thereby it is checked whether or not it has passed the if-sentence in line 504 of the source program 106 in FIG. 5. In a case where a comparison result of the above condition comparison instruction is equal, by a conditional branch of a next “beg L4” instruction (an instruction 1012), a branch is made to a label L4 (an instruction 1014), and after the EXECUTION SENTENCE 2 (an instruction 1015) is executed, the procedure gets out of the multiple conditional branch by a branch instruction (an instruction 1016). In a case where a comparison result of the condition comparison instruction of an instruction 1011 is not equal, a branch is not made by the conditional branch instruction (an instruction 1012), and a branch is made to the error processing (error ( )) by a next branch instruction (an instruction 1013).

In a case where a comparison result of the above condition comparison instruction of instruction 1008 is equal, by a conditional branch instruction of instruction 1010, a branch is made to a label L3 (an instruction 1017), and the procedure transits to a condition comparison instruction of instruction 1018. It is checked whether or not 1 is set to the 0th bit and the 1st bit of the register R1 (the value of R1 is 3), thereby it is checked whether or not the procedure has passed the if-sentences in line 504 and line 506 of the source program 106 in FIG. 5. In a case where a comparison result of the above condition comparison instruction is equal, by a next conditional branch instruction (an instruction 1019), a branch is made to a label L5 (an instruction 1021), and after the EXECUTION SENTENCE 3 (an instruction 1022) is executed, the procedure gets out of the multiple conditional branch. In a case where a comparison result of the above condition comparison instruction of an instruction 1018 is not equal, a branch is not made by a conditional branch instruction (an instruction 1019), and a branch is made to the error processing (error ( )) by a next branch instruction (an instruction 1020). Thus, in a case where it is judged that it has not passed a correct route in the way of execution of the executable program 107, the procedure transits to the error processing, and therefore, possibility of malfunction is lowered.

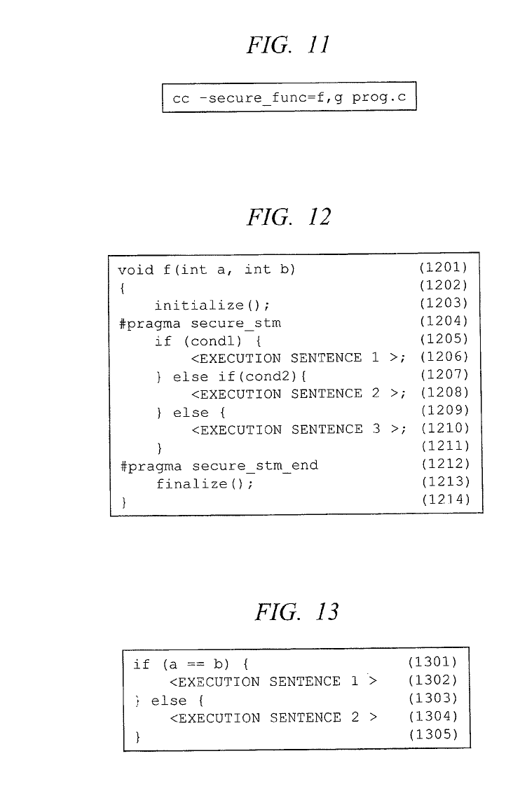

In the present embodiment, in FIG. 5, the function for inserting tamper-resistant code is designated by #pragma instruction sentence in the source program 106, however, the present invention is not limited to this, but it may be designated by compile option added to a compiler start command. FIG. 11 shows an example thereof. Here, “cc” indicates a compile command, “prog.c” indicates a compile objective file (a source program), and “-secure_func=f, g” shows that a function f and a function g are designated as objective functions for the tamper-resistant code insertion. That is, it shows that by the compile command in FIG. 11, the tamper-resistant code insertion is carried out to the function f and the function g in the source program prog.c, but to other functions, the tamper-resistant code insertion is not carried out as usual and an assembly language program 206 is generated.

And, in the present embodiment, in FIG. 5, whether or not to insert tamper-resistant code is designated for each function, but it can also be designated in more detailed degree (for example, in unit of an sentence of the source program 106). FIG. 12 shows an example of such a designation. In FIG. 12, it is designated to carry out tamper-resistant code insertion to sentences in a range enclosed by “#pragma secure_stm” (an instruction 1204) and “#pragma secure_stm_end” (an instruction 1212) in a function. In such a case, in generation of representation language 109 by the compiler 201, flag indicating whether or not a function is tamper-resistant code insertion objective is set not for each function but for each instruction in the intermediate language 109, thereby it becomes possible to control the tamper-resistant code insertion for each instruction.

Note that, in the optimization processing at step 407 in FIG. 4, with regard to an instruction of the intermediate representation 109 whose processed flag of the tamper-resistant code insertion processing are turned ON, it is set not to be deleted or deformed as a redundant instruction, and an inserted tamper-resistant code is set to be kept also in the optimization processing.

As described above, by the language tool 108 according to the present embodiment, the executable program 107 having tamper-resistance, that can be hardly generated manually by users, such as branch route verification of multiple conditional branch can be generated automatically, and therefore, development productivity of application having tamper-resistance is improved.

### Second Embodiment

Hereinafter, as a second embodiment of the present invention, an example of a language tool generating an executable program with conditional branch judgment multiplexed is explained.

A configuration diagram showing an example of an information processing device on which the language tool according to the present embodiment operates is the same as FIG. 1. And, examples of structure and a processing outline of the language tool 108 according to the present embodiment are the same as FIG. 2. Furthermore, a configuration diagram showing an example of a target microcomputer 208 in which an executable program 107 generated by the language tool 108 according to the present embodiment operates is the same as FIG. 3. And, an example of a processing flow in a compiler 201 according to the present embodiment is the same as FIG. 4. Since detail of a tamper-resistant code insertion processing at step 405 in FIG. 4 is different from that in the first embodiment, it is explained in more detail with reference to FIG. 13 to FIG. 16.

FIG. 13 shows an example of a source program 106 inputted to the language tool 108 according to the present embodiment. It shows that in line 1301, values of variable a and variable b are compared, and in a case where they are equal, EXECUTION SENTENCE 1 in line 1302 is executed, and in a case where it is not equal, EXECUTION SENTENCE 2 in line 1304 is executed.

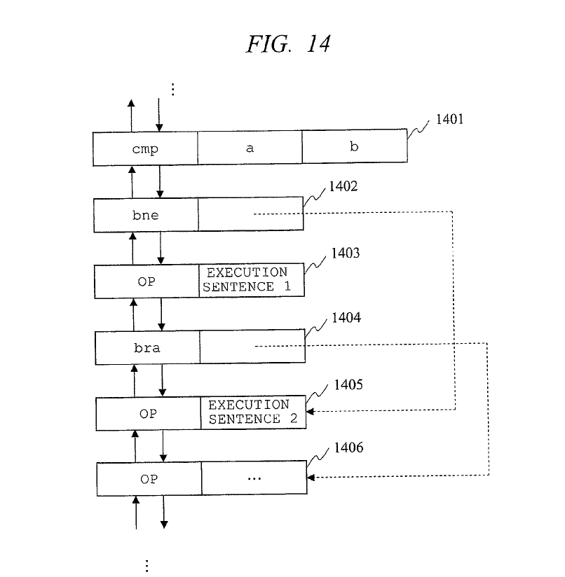

FIG. 14 shows an example of intermediate representation 109 generated by the language tool 108 according to the present embodiment before the tamper-resistant code insertion processing at step 405 in FIG. 4. In the same manner as in FIG. 6 in the first embodiment, the intermediate representation at a level near machine language is supposed in the present embodiment. The point that structure in which memory cells called instructions are linked in a list form by dual link is employed is also in the same as FIG. 6.

The intermediate representation 109 in FIG. 14 corresponds to a portion from line 1301 to line 1305 of the source program 106 in FIG. 13. An instruction 1401 (cmp) means to compare a variable a and a variable b. An instruction 1402 (bne) means to branch to an instruction 1405 designated (linked) by a pointer of operand, if a and b are not equal (Not Equal) as a result of the above comparison. In a case where it is (equal), the procedure transits to an instruction 1403 just next (fall-through). An instruction 1403 is a sentence corresponding to EXECUTION SENTENCE 1 in line 1302 of the source program 106 in FIG. 13. Although it is shown by one instruction here, there are cases in which it is composed of plural instructions. An instruction 1404 (bra) means to unconditionally branch to an instruction 1406 designated by a pointer of operand.

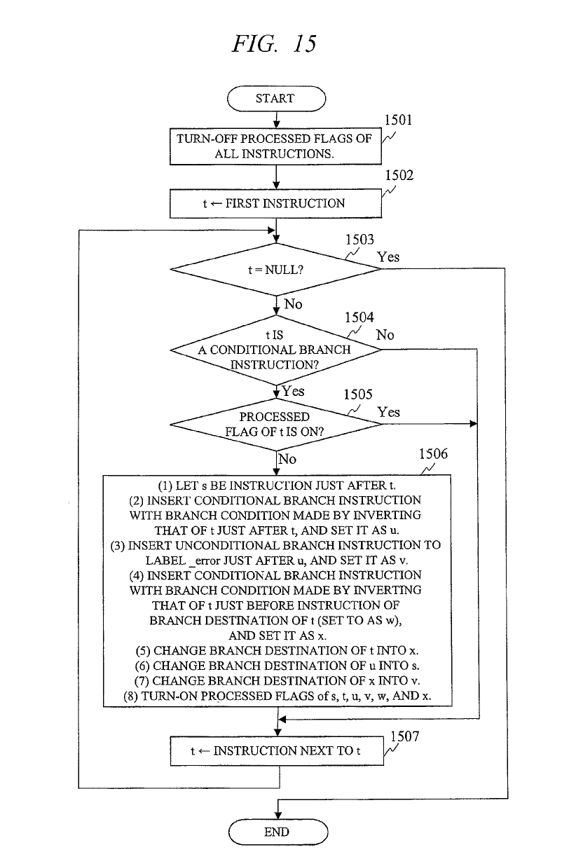

FIG. 15 is a flow chart showing a detailed example of the tamper-resistant code insertion processing at step 405 in FIG. 4 according to the present embodiment. First, at step 1501, processed flags of all instructions in the intermediate representation 109 are turned OFF. Next, at step 1502, a first instruction in the intermediate representation 109 is taken out, and it is set as t. Next, at step 1503, it is checked whether or not t is NULL. If it is NULL, all instructions are already processed, and therefore, the procedure ends. If it is not NULL, the procedure transits to step 1504, and it is checked whether or not t is a conditional branch instruction. If it is not a conditional branch instruction, the procedure transits to step 1507, the next instruction of t is newly set as t, and the processing are repeated from step 1503. If t is a conditional branch instruction at the step 1504, it is checked whether or not a processed flag of t is ON at step 1505. If it is ON, the procedure transits to step 1507, and if it is not ON, the procedure transits to step 1506.

At step 1506, following processing (1) to (8) are carried out.

(1) Let s be an instruction just after t.

(2) Insert a conditional branch instruction with a branch condition made by inverting that of t just after t, and set it as u.

(3) Insert an unconditional branch instruction to label_error just after u, and set it as v.

(4) Insert a conditional branch instruction with a branch condition made by inverting that of t just before an instruction of a branch destination of t (set to as w) and set it as x.

(5) Change a branch destination of t into x.

(6) Change a branch destination of u into s.

(7) Change a branch destination of x into v.

(8) Turn-on processed flags of s, t, u, v, w, and x.

After completion of the above processings (1) to (8), the procedure transits to step 1507.

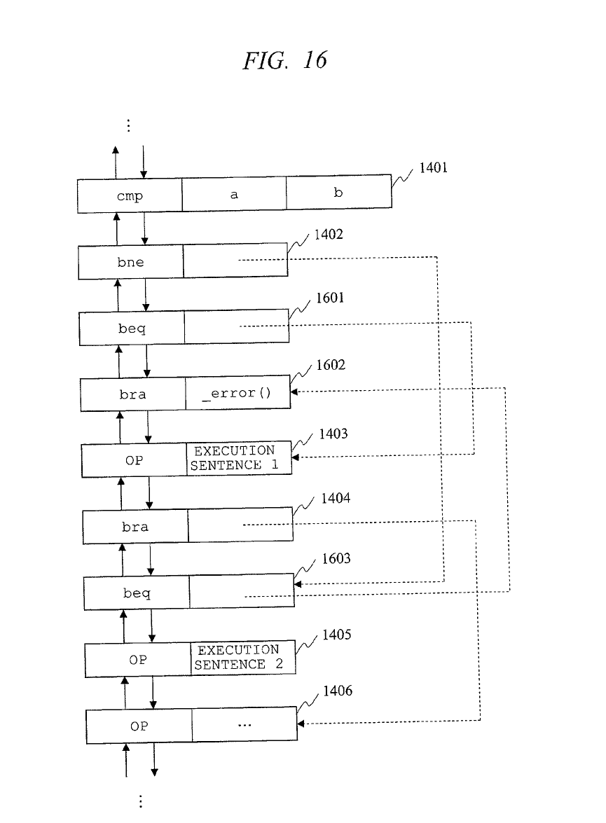

FIG. 16 shows an example of intermediate representation 109 after the tamper-resistant code insertion processing shown in FIG. 15 is carried out to the intermediate representation 109 in FIG. 14. Hereinafter, a processing generating the intermediate representation 109 is shown according to a processing flow in FIG. 15.

At step 1502, a first instruction (an instruction 1401) is taken out, and it is set as t. At step 1503, it is checked whether or not t is NULL. Since t is not NULL, the procedure transits to step 1504, and it is checked whether or not t is a conditional branch instruction. Since t is not a conditional branch instruction, the procedure transits to step 1507, and an instruction next to t (an instruction 1402) is newly set as t. And again, at step 1503, it is checked whether or not t is NULL. Since t is not NULL, at step 1504, it is checked whether or not t is a conditional branch instruction. Since t is a conditional branch instruction, the procedure transits to step 1505, and it is checked whether or not the processed flag is ON. Since the processed flag is OFF, the procedure transits to step 1506.

At step 1506, following processing (1) to (8) are carried out.

(1) Let s be an instruction (an instruction 1403) just after t.

(2) Insert a conditional branch instruction with a branch condition made by inverting that of t just after t, and set it as u. Since a branch condition of t is “ne (Not Equal)”, a condition made by inverting it is “eq (Equal)”. An instruction 1601 in FIG. 16 corresponds to u.

(3) Insert an unconditional branch instruction to label_error just after u, and set it as v. An instruction 1602 in FIG. 16 corresponds to v.

(4) Since an instruction of a branch destination of t is an instruction 1405 in FIG. 14, it is set as w, and a conditional branch instruction with a branch condition made by inverting that of t is inserted just before w, and set as x. An instruction 1603 in FIG. 16 corresponds to x.

(5) Change a branch destination of t (an instruction 1402) into x (an instruction 1603).

(6) Change a branch destination of u (an instruction 1601) into s (an instruction 1403).

(7) Change a branch destination of x (an instruction 1603) into v (an instruction 1602).

(8) Turn-on processed flags of s, t, u, v, w, and x.

Next, the procedure transits to step 1507, an instruction (an instruction 1601) next to t is newly set as t, and the procedure goes back to step 1503. And again, at step 1503, it is checked whether or not t is NULL, since t is not NULL, the procedure transits to step 1504, and it is checked whether or not t is a conditional branch instruction. Since t (an instruction 1601) is a conditional branch instruction, the procedure transits to step 1505, and it is checked whether or not a processed flag of t is ON. Since the processed flag of instruction 1601 has been turned ON in the processing (8) of above described step 1506, the procedure transits to step 1507, and an instruction (an instruction 1602) next to t is newly set as t, and the processings from step 1503 are carried out again. At this moment, since there is no instruction that is a conditional branch instruction with a processed flag set OFF in the intermediate representation 109 under the processing, in a processing after this, the procedure does not transit to step 1506, and the tamper-resistant code insertion processing is not carried out.

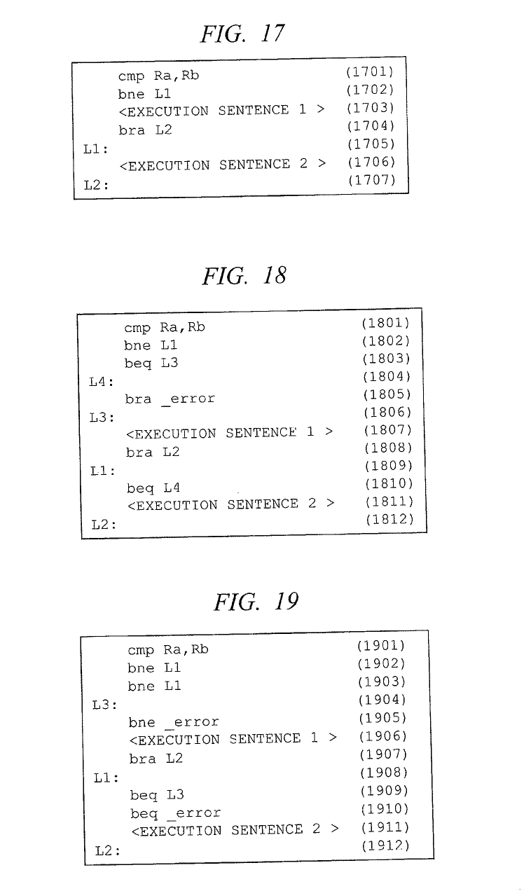

FIG. 17 shows an example of an assembly language program outputted by a compiler according to the conventional art when the source program 106 in FIG. 13 is used as input. First, by “cmp Ra, Rb” instruction (an instruction 1701), values of a register Ra holding a value of variable a and a register Rb holding a value of variable b are compared, and the result is stored in a condition code register. In a next instruction 1702, the value of the condition code register is checked, and in a case where the comparison result is not equal, a branch is made to a label L1 (an instruction 1705). In a case where it is (equal), the procedure transits to an instruction just next, EXECUTION SENTENCE 1 (an instruction 1703) is executed, and a branch is made to label L2 (an instruction 1707) by an instruction 1704. In a case where branch is made to L1 by an instruction 1702, after EXECUTION SENTENCE 2 (an instruction 1706) is executed, the procedure transits to an instruction just next.

FIG. 18 shows an example of an assembly language program 206 outputted by the language tool 108 according to the present embodiment when the source program 106 in FIG. 13 is used as input. Here, two of conditional branch instructions corresponding to an if-sentence in line 1301 of the source program 106 in FIG. 13 are arranged continuously, as an instruction 1802 to an instruction 1803. Thereby, even if a first conditional branch instruction makes a fall-through branch unjustly by an attack such as the fault based attack and the like, condition judgment is carried out again by a second conditional branch instruction, and accordingly, possibility of malfunction is lowered.

Note that, in the assembly language program 206 in FIG. 18, as shown in the instruction 1802 to the instruction 1803, a conditional branch is carried out continuously with an inverted branch condition, however, a code in which a branch condition is not inverted and a conditional branch is carried out continuously may be generated. An example of the assembly language program 206 of this style is shown in FIG. 19.

In an instruction 1902 to an instruction 1903, conditional branch instructions of the same branch condition are arranged continuously. Also in this case, even if a first conditional branch instruction 1902 makes a fall-through branch unjustly by the fault based attack and the like, condition judgment is carried out again by a next conditional branch instruction 1903, and accordingly, possibility of malfunction is lowered. In a case where branch is not made at an instruction 1902 or an instruction 1903, judgment is made at an instruction 1905 further with the same branch condition, and if judgment to branch is made here, a branch is made to the error processing (error ( )). Further, on the contrary, even if the first conditional branch instruction 1902 makes branch to a label L1 (an instruction 1908) unjustly by the fault based attack, a branch condition is checked again at an instruction 1909, and the procedure is set to return to a label L3 (an instruction 1904), which is a correct branch direction. In a case where branch is not made to L3 at an instruction 1909, check is performed at an instruction 1910 with the same branch condition further, and if the procedure is not returned to the correct branch direction, branch is made to the error processing (error ( )).

In the examples of the assembly language program 206 in FIG. 18 and FIG. 19, two conditional branch instructions are arranged and multiplexed. Three or more conditional branch instructions can be arranged and multiplexed.

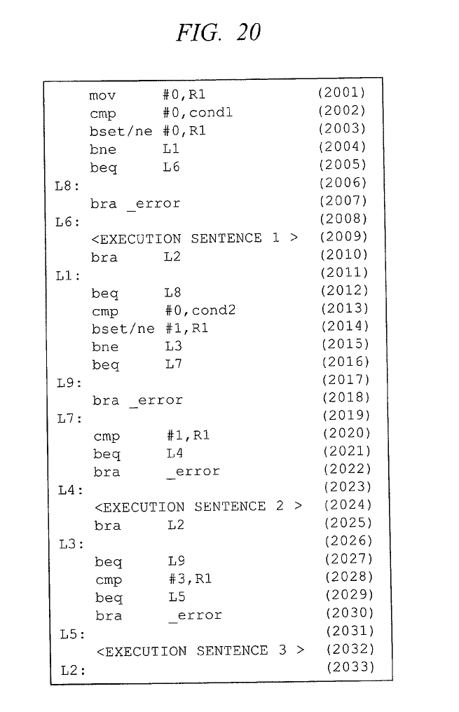

FIG. 20 shows an example of the assembly language program 206 outputted by the language tool 108 using the source program 106 in FIG. 5 as input, in a case where the processing inserting a code performing branch route verification of multiplex conditional branch described in the first embodiment is combined with the language tool 108 according to the present embodiment. In comparison with the assembly language program 206 in FIG. 10 which is an output result of the tamper-resistant code insertion processing by the language tool 108 in the first embodiment, a label 2006 and an instruction 2007, a label 2017 and an instruction 2018, and respective conditional branch instructions of an instruction 2005, an instruction 2012, an instruction 2016 and an instruction 2027 are additionally inserted by the processing in the language tool 108 according to the present embodiment.

Note that, in FIG. 20, a conditional branch instruction multiplexed by the language tool 108 according to the present embodiment is only that corresponding to a conditional branch instruction existing in the source program 106 in FIG. 5, and conditional branch instructions (an instruction 2021, instruction 2029) inserted by the processing by the language tool 108 according to the first embodiment are not multiplexed, but the conditional branch instructions can be multiplexed.

Similarly to the first embodiment, also in the present embodiment, a function to which a tamper-resistant code is inserted is designated by #pragma instruction sentence in the source program 106. It may also be designated by compile option added to a compiler start command. Further, whether or not to insert a tamper-resistant code can be designated not only for each function, but for more detailed degree.

And, similarly to the first embodiment, in an optimization processing at step 407 in FIG. 4, with regard to an instruction of the intermediate representation 109 whose processed flags of the tamper-resistant code insertion processing are turned ON, it is set not to be deleted or deformed as a redundant instruction, and an inserted tamper-resistant code is set to be kept also in an optimization processing.

As described above, by the language tool 108 according to the present embodiment, the executable program 107 having tamper-resistance that can be hardly generated manually by a user, such as multiplexing of conditional branch judgment, can be generated automatically, and therefore, development productivity of application having tamper-resistance is improved.

### Third Embodiment

Hereinafter, as a third embodiment of the present invention, an example of a language tool generating an executable program checking a parameter content at function call is explained.

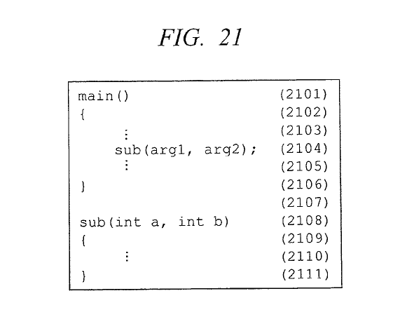

A configuration diagram showing an example of an information processing device on which the language tool according to the present embodiment operates is the same as FIG. 1. And, examples of structure and a processing outline of the language tool 108 according to the present embodiment are the same as FIG. 2. Furthermore, a configuration diagram showing an example of a target microcomputer 208 in which an executable program 107 generated by the language tool 108 according to the present embodiment operates is the same as FIG. 3. And, an example of a processing flow in a compiler 201 according to the present embodiment is the same as FIG. 4. Since detail of a tamper-resistant code insertion processing at step 405 in FIG. 4 is different from that in the first embodiment and the second embodiment, it is explained in more detail with reference to FIG. 21 to FIG. 24.

FIG. 21 shows an example of the source program 106 inputted to the language tool 108 according to the present embodiment. It shows that a function main (line 2101 to line 2106) calls a function sub (line 2108 to line 2111) at line 2104 with setting arg1 and arg2 as actual arguments.

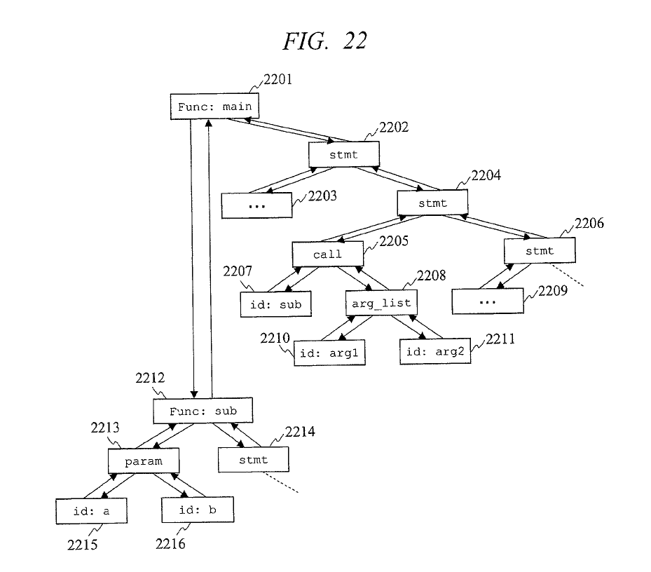

FIG. 22 shows an example of an intermediate representation 109 generated by the language tool 108 according the present embodiment, before the tamper-resistant code insertion processing at step 405 in FIG. 4. The intermediate representation generated by the compiler includes in general a representation at a level near a source program, to a representation at a level near machine language. In the present embodiment, that at a level near the source program is supposed. The intermediate representation 109 has structure in which memory cells called nodes are connected by dual link in a tree form, one function of the source program 106 corresponds to one tree, and structure in which nodes each corresponding to a root of tree are connected by dual link in a list form is employed. Arrows in the diagram represent links between nodes.

The intermediate representation 109 shown in FIG. 22 corresponds to the source program 106 in FIG. 21. A node 2201 is a node representing a head sentence (line 2101) of the function main. To the node 2201, an stmt node 2202 representing a first execution sentence (line 2103) in the function is connected. To the stmt node 2202, a node 2203 representing a processing content of the above execution sentence (line 2103) and an stmt node 2204 representing a next execution sentence (line 2104) are connected. In the same manner, an stmt node 2206 represents a sentence (line 2105) executed after the stmt node 2204.

To the stmt node 2204, a call node 2205 representing a function call which is a processing content of the line 2104 is connected. To the call node 2205, an id node 2207 representing a function sub of a call destination and an arg_list node 2208 representing a list of actual arguments are connected. To the arg_list node 2208, an id node 2210 and id node 2211 representing actual arguments arg1, arg2 of a function call are connected.

A node 2212 is a node representing a head sentence (line 2108) of a next function sub. To the node 2212, a param node 2213 representing a formal argument list of the function and an stmt node 2214 representing a first execution sentence in the function (line 2110) are connected. To the param node 2213, an id node 2215 and an id node 2216 representing formal arguments a, b are connected. The node 2201 and the node 2212 representing the head sentences of functions are connected by dual link in a list form.

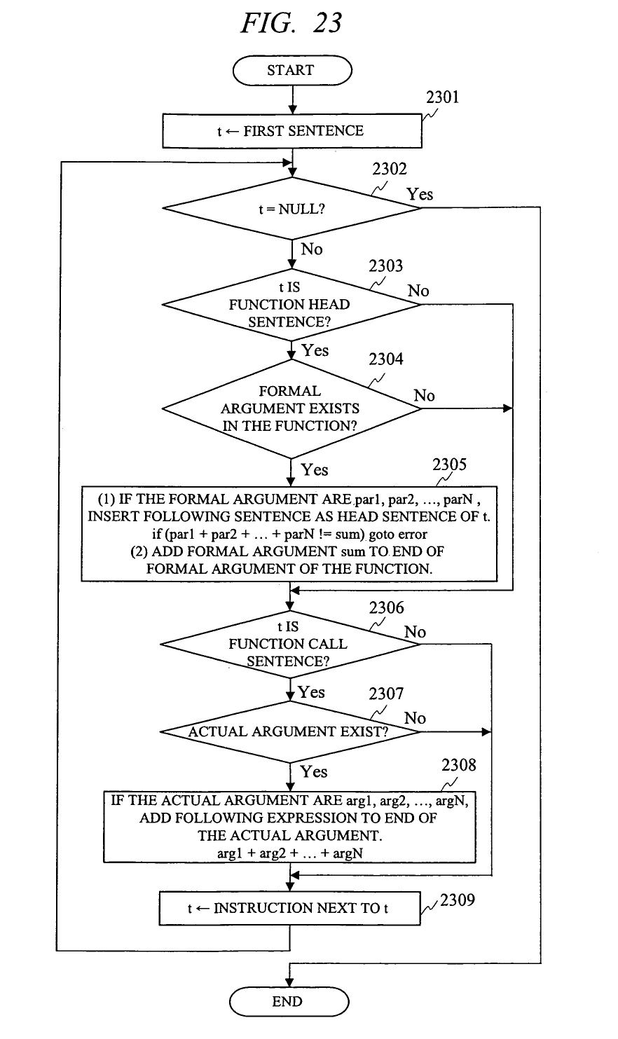

FIG. 23 is a flow chart showing a detailed example of the tamper-resistant code insertion processing at step 405 in FIG. 4.

First, at step 2301, a node of a head sentence of the intermediate representation 109 is taken out, and it is set as t. Next, at step 2302, it is checked whether or not t is NULL. If it is NULL, all nodes are already processed and the processing ends. If it is not NULL, the procedure transits to step 2303, and it is checked whether or not t is a node of a function head sentence. If t is not a node of the function head sentence, the procedure transits to step 2306. If t is a node of the function head sentence, the procedure transits to step 2304, and it is checked whether or not a formal argument exists in the function. If no formal argument exists, the procedure transits to step 2306, and if a formal argument exists, the procedure transits to step 2305.

At the step 2305, following processings (1) to (2) are carried out.

(1) If the above formal arguments are defined as par1, par2, . . . , parN,

insert a node corresponding to following execution sentence,

if (par1+par2+ . . . +parN !=sum) goto error

as a node of a head execution sentence of the function. A node of an original head execution sentence is connected as a next execution sentence of the above node newly inserted.

(2) To an end of formal arguments of the function, add a formal argument sum.

Next, at step 2306, it is checked whether or not t is a node of a function call sentence. If t is not a node of a function call sentence, the procedure transits to 2309, and a node of a sentence next to t is newly set as t, and the processing are repeated from the step 2302. If t is a node of a function call sentence, the procedure transits to step 2307, and it is checked whether or not an actual argument exists in the function call. If no actual argument exists, the procedure transits to step 2309. If an actual argument exists, the procedure transits to step 2308, and when the actual arguments are defined as arg1, arg2, . . . , argN, arg1+arg2+ . . . +argN is added to an end of the actual arguments, and the procedure transits to step 2309.

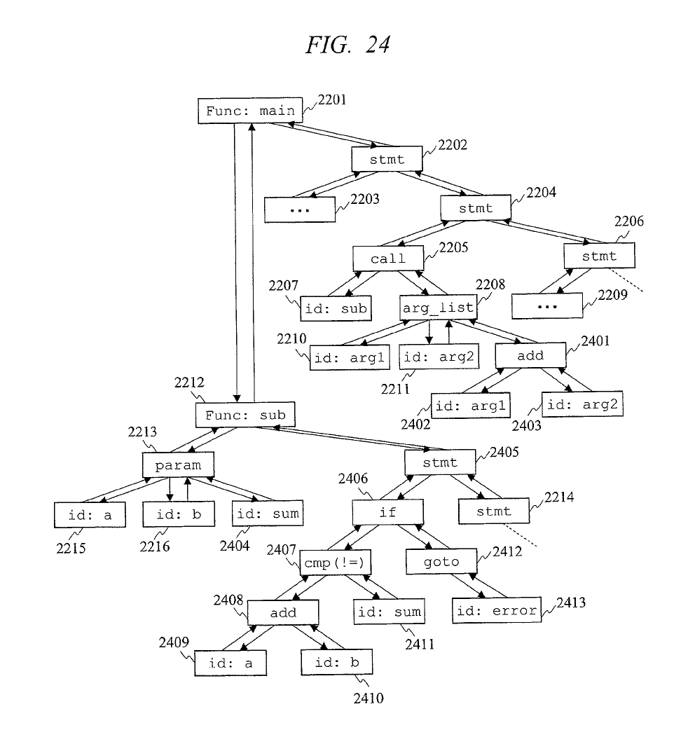

FIG. 24 shows an example of the intermediate representation 109 after the tamper-resistant code insertion processing shown in FIG. 23 is carried out to the intermediate representation 109 in FIG. 22. Hereinafter, according to the processing flow in FIG. 23, the processing generating the intermediate representation 109 is shown.

First, at step 2301, a first node (a node 2201) is taken out from the intermediate representation 109 in FIG. 22, and it is set as t. Next, at step 2302, it is checked whether or not t is NULL. Since t is not NULL, the procedure transits to step 2303 and it is checked whether or not t is a node of a function head sentence. Since t is a node of a head sentence of a function main, the procedure transits to step 2304, and it is checked whether or not a formal argument exists in the function. Since no formal argument exists in the function, the procedure transits to step 2306, and it is checked whether or not t is a node of a function call sentence. Since t is not a node of a function call sentence, the procedure transits to step 2309, and a node (a node 2202) of a sentence next to t is newly set as t. Since the node 2202 is neither a function head sentence nor a function call sentence, no processing is carried out, and at step 2309, a node 2204 is newly set as t.

Since t is not a node of a function head sentence, the procedure is carried out in the same way as a case of the node 2202 to the processing moving from step 2303 to step 2306. Since a call node 2205 is connected to a node 2204 and it is a node of a function call sentence, the procedure transits to step 2307, and it is checked whether or not an actual argument exists in the function call sentence. Since an arg_list node 2208 of an actual argument list is connected to a call node 2205, an actual argument exists, and therefore, the procedure transits to step 2308.

At step 2308, since the above actual arguments are arg1 and arg2, arg1+arg2 is added to an end of the actual argument list (a node 2401 to a node 2403), and the procedure transits to step 2309. Next, a sentence (a node 2206) next to t is set as new t. After this, since a node of a sentence in the function main is neither a function head sentence nor a function call sentence in the same manner as the node 2202, the tamper-resistant code insertion processing is not carried out.

After completion of a processing of execution sentences in the function main, the procedure transits to the processing of a next function. A node 2212 is set as t, and it is checked whether or not t is NULL at step 2302. Since t is not NULL, the procedure transits to step 2303, and it is checked whether or not t is a node of a function head sentence. Since t is a node of a head sentence of a function sub, the procedure transits to step 2304, and it is checked whether or not a formal argument exists in the function. Since a param node 2213 is connected to node 2212 and a formal argument exists, the procedure transits to step 2305.

At the step 2305, following processings (1) to (2) are carried out.

(1) Because of an id node 2215 and an id node 2216 connected to param node 2213, formal arguments are a, b. And therefore, insert nodes (a node 2405 to a node 2413) corresponding to an execution sentence “if (a+b !=sum) goto error” as a node of a head execution sentence of the function sub. Connect an stmt node 2214 of an original head execution sentence as an execution sentence next to an stmt node 2405 newly inserted.

(2) To an end of formal arguments of the function sub, insert formal argument sum (a node 2404).

Next, the procedure transits to step 2306, and it is checked whether or not t is a node of a function call sentence. Since t is not a node of a function call sentence, the procedure transits to step 2309, and a node (a node 2214) of a sentence next to t is newly set as t. After this, since sentences in the function include neither a function head sentence nor a function call sentence, the procedure does not go to step 2305 and step 2308, and therefore, the tamper-resistant code insertion processing is not carried out.

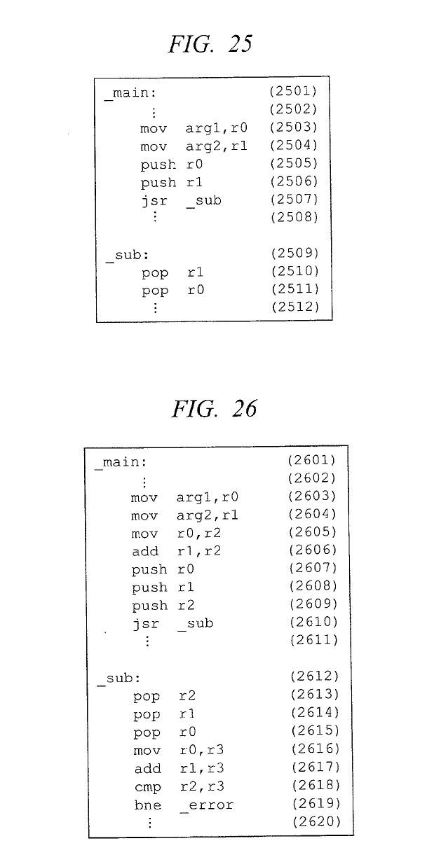

FIG. 25 shows an example of an assembly language program outputted by the compiler according to the conventional art, in a case where the source program 106 in FIG. 21 is used as input. First, in a function main, a value of arg1 is set to a register r0 by a “mov arg1, r0” instruction (an instruction 2503), and a value of arg2 is set to a register r1 by a “mov arg2, r1” instruction (an instruction 2504), respectively. Next, by a “push” instruction (an instruction 2505, an instruction 2506), values of registers r0, r1 are pushed on a stuck as parameters and made ready to be delivered to a function of a call destination, and by “jsr_sub” instruction (an instruction 2507), a function sub is called. In the function sub, by “pop” instruction (an instruction 2510, an instruction 2511), a delivered parameter value is returned to a register.

FIG. 26 shows an example of an assembly language program 206 outputted by the language tool 108 according to the present embodiment in a case where the source program 106 in FIG. 21 is used as input. In the assembly language program 206 in FIG. 26, with respect to an instruction (instruction 2610) corresponding to call of a function sub in line 2104 of the source program 106 in FIG. 21, addition of values of actual arguments arg1 and arg2 is set to a register r2 by an instruction 2605 and an instruction 2606, and it is pushed on a stuck as an actual argument at an end by “push” instruction of an instruction 2609, and delivered to the function sub.

In a processing of the called function sub, first, by “pop” instructions of an instruction 2613 to an instruction 2615, parameter values are returned to registers r0, r1, r2. Next, by an instruction 2616 and an instruction 2617, values (r0, r1) of parameters corresponding to formal arguments a, b are added to a register r3. Next, by an instruction 2618, a value (r2) of a parameter corresponding to added formal argument sum and a value of the above r3 are compared. If a result of the comparison is not equal (ne), a branch is made to an error processing (error ( )) by an instruction 2619. And thereby, if a parameter value is changed unjustly by an attack such as the fault based attack and the like in executing function call, the procedure transits to the error processing, and accordingly, possibility of malfunction is lowered.

Similarly to the first embodiment, also in the present embodiment, functions to which tamper-resistant codes are inserted are designated by a #pragma instruction sentence in the source program 106. It may also be designated by compile option added to a compiler start command. Further, whether or not to insert tamper-resistant code can be designated not only for a function, but for more detailed degree.

Further, similarly to the first embodiment, in an optimization processing at step 407 in FIG. 4, with regard to an instruction of the intermediate representation 109 whose processed flag of the tamper-resistant code insertion processing is turned ON, it is set not to be deleted or deformed as a redundant instruction, and an inserted tamper-resistant code is set to be kept also in an optimization processing.

As explained above, by the language tool 108 according to the present embodiment, an executable program 107 having tamper-resistance, which can be hardly generated manually by a user, such as parameter content check at a function call, can be generated automatically and therefore, development productivity of application having tamper-resistance are improved.

### Fourth Embodiment

As a fourth embodiment, an example of a language tool generating a machine language diluting a feature of a current characteristic at execution, by performing current characteristic complication by code generation of plural patterns for a loop processing is explained.

If a loop processing in a source program (a for-sentence, a while-sentence, a do-while-sentence and the like in C language) is translated directly into machine language and an executable program is generated, since the executable program executes a similar processing repeatedly, a feature with a certain pattern appears in a current characteristic at execution. Such a distinctive current characteristic causes a high risk to give opportunities of unjust operation analysis to attackers.

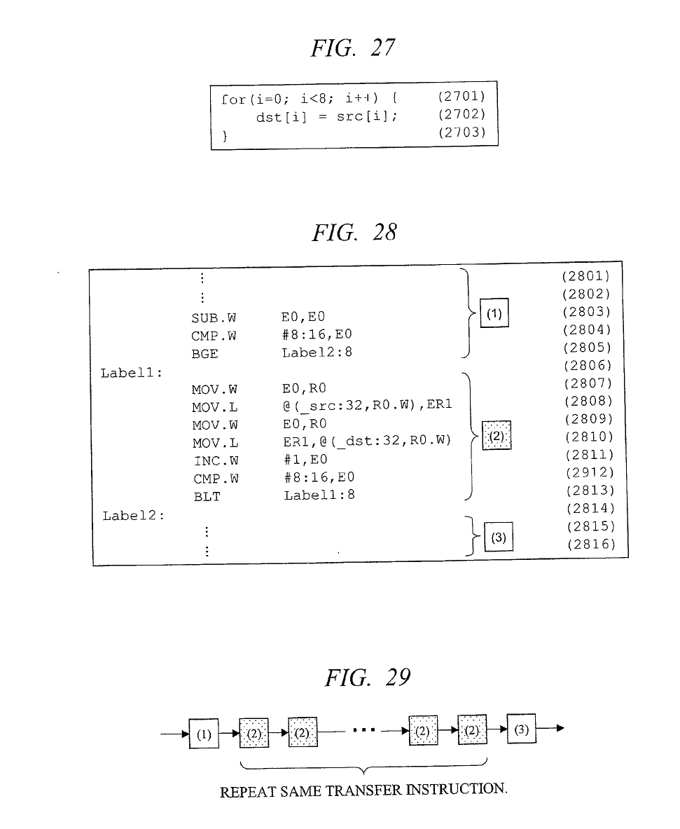

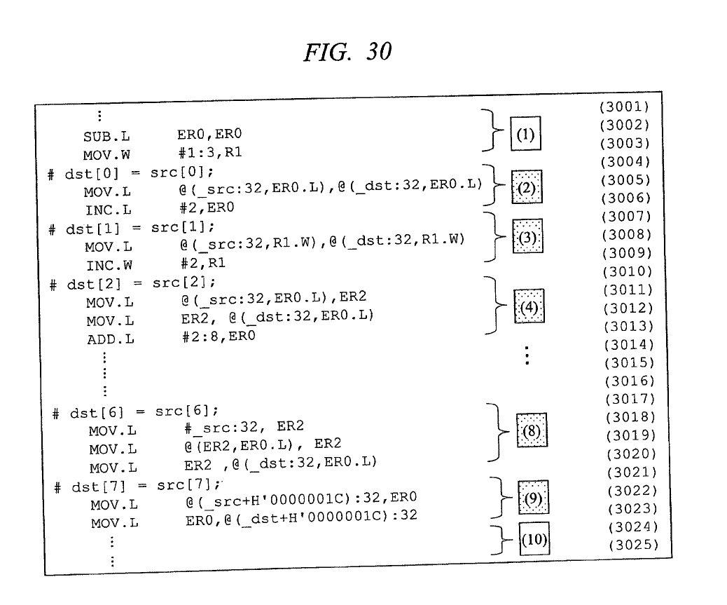

FIG. 27 shows an example of a source program of C language in which a loop processing is described, and the program performs a simple data transfer processing repeatedly. FIG. 28 shows an example of a machine language instruction sequence represented by assembler description, obtained as a result of compiling of the source program in FIG. 27 by the conventional language tool. Among processing blocks shown by (1) to (3) in FIG. 28, a processing block of (2) is a portion executing a data transfer processing in line 2702 in FIG. 27, which is a content of the loop processing. FIG. 29 is a diagram showing an example of processing order in a case in which the program in FIG. 28 is executed, and shows that the data transfer processing of (2) in FIG. 28 is executed repeatedly. In this case, a similar current characteristic is repeated in a short cycle, and there is a risk that it is presumed that a loop processing is executed from the characteristic.

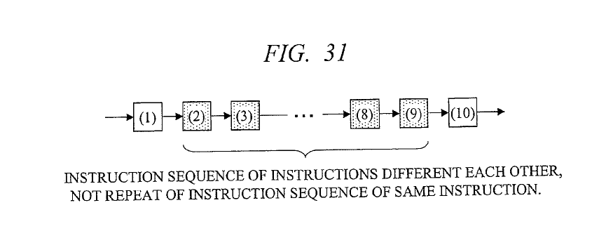

And therefore, in the language tool according to the present embodiment, with regard to a processing in a loop, processings of the same content are expanded by an instruction sequence of plural patterns, and therefore, the processing is complicated. FIG. 30 is an example of machine language represented by assembler description, obtained as a result of compiling of the source program in FIG. 27 with a loop processing complicated. Among processing blocks shown by (1) to (10) in FIG. 30, processing blocks of (2) to (9) represent a data transfer processing in line 2702 in FIG. 27 which is a content of a loop processing, in an instruction sequence of plural patterns which are different each other. FIG. 31 is a diagram showing an example of processing order in a case where the program in FIG. 30 is executed, and shows that the processing blocks of (2) to (9) in FIG. 30 are executed in order.

And thereby, the processing is carried out not by repetition of the same instruction sequence for each loop, but by an instruction sequence of plural patterns different respectively. And therefore, regularity of a current characteristic in a case of executing a simple loop processing can be diluted. Accordingly, at execution, a seemingly-irregular current characteristic is obtained, and it becomes difficult to distinguish the loop processing from execution of a processing other than the loop processing, and therefore, it is possible to make difficult for attackers to perform unjust operation analysis.

Such an instruction sequence of machine language can be generated manually by a user. But since it requires knowledge of low-level language such as assembly language or the like, a technical barrier exists and many man-hours are required. So, by adding a function automatically making the processing in a loop complicated to a language tool, automatic generation of such an instruction sequence of machine language is realized. In this case, in order to generate an instruction sequence of plural patterns for a certain processing, many processing patterns are memorized in the language tool, and patterns of necessary number are embedded to the objective loop processing.

Hereinafter, concrete contents of the language tool according to the present embodiment are explained. A configuration diagram showing an example of an information processing device on which the language tool according to the present embodiment operates is the same as FIG. 1. And, examples of structure and a processing outline of the language tool 108 according to the present embodiment are the same as FIG. 2. Furthermore, a configuration diagram showing an example of a target microcomputer 208 in which an executable program 107 generated by the language tool 108 according to the present embodiment operates is the same as FIG. 3. And, an example of a processing flow in a compiler 201 according to the present embodiment is the same as FIG. 4.

How the loop processing in the source program 106 is made complicated by the tamper-resistant code insertion processing at step 405 in FIG. 4 is explained using a simple example. In general, in a loop processing described in the source program 106, the number of times of loops is large, and therefore, if all of the loop processings are expanded at once as shown in the example in FIG. 30, size of the program may diverge. Further, in many cases, the number of times of loops is not fixed beforehand and the number of times of loops is not determined until execution, and accordingly, it is not realistic to expand all processing in a loop at once.

And therefore, separately from expansion of the processing in the loop uniformly by all patterns as shown in the example in FIG. 30, expansion into plural patterns is performed effectively by following processing.

(1) Until the number of patterns reaches the number designated by user, generate a processing in a loop by instruction sequence by the plural patterns.

(2) Sort executions of generated instruction sequences of plural patterns into a form of a switch-sentence and the like.

(3) Set variable used in sorting in the switch-sentence and a calculation formula thereof.

(4) Loop the switch-sentence for the number of times described in the source program 106.

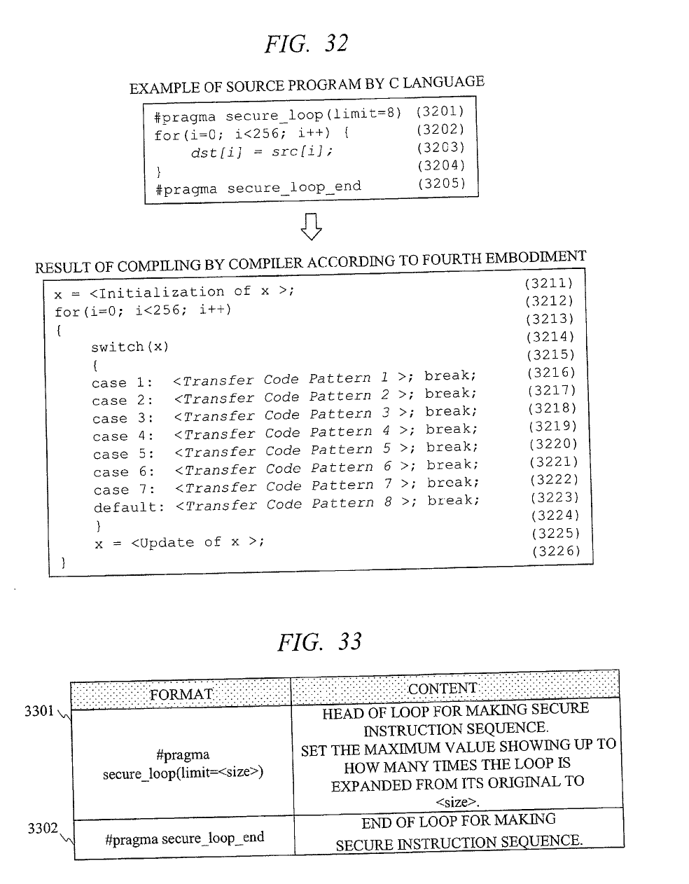

An example of code generation in a case where a loop processing is expanded into an instruction sequence of plural patterns is shown in FIG. 32. FIG. 32 shows an example of the source program 106 in which a loop processing is described in C language, and a result of compiling of the source program 106 by a compiler 201 according to the present embodiment. Note that, the result of compile is expressed in form of a pseudo program not in assembly language but in C language for making explanation simple.

Line 3202 to line 3204 of the source program 106 show an example of a loop processing performing a simple data transfer. In a case where the loop processing is a loop whose processing content should not be known to others, a user can designate the loop processing as an objective range of the tamper-resistant code insertion processing, by extended language specification #pragma of line 3201 and line 3205. FIG. 33 shows an example of a format by the extended language specification #pragma in a case where the source program 106 is described in C language. Here, at head of the loop, maximum size of expansion of the loop processing by an instruction sequence of plural patterns can be designated by #pragma of a format 3301. And thereby, divergence of the program size can be prevented.

By procedure of the above (1), a processing of line 3203 is expanded into eight processing patterns which is maximum size designated by #pragma of line 3201, as shown in line 3216 to line 3223. Here, processings “Transfer Code Pattern x” of line 3216 to line 3223 show realizations of the same operation contents as data transfer processing in line 3203, by different instruction sequences respectively.

Further, by a procedure of the above (2), processings of line 3216 to line 3223 are sorted by a switch-sentence in line 3214. And, by a procedure of the above (3), a variable x used in the switch-sentence in line 3214 is set and updated in line 3211 and line 3225. Moreover, by a procedure of the above (4), by a for-sentence in line 3212, processings of line 3214 to line 3225 are looped by the same number of times as number of times of a loop designated in line 3202 of the source program 106.

By these processing, processing time and a current characteristic in execution of the loop processings in line 3212 to line 3226 become different for each loop, and it is hardly presumed that they are operations of the same content. In this case, even if respective data transfer patterns are executed in order, a current characteristic cycle of the processing in a loop simply becomes eight times, and by innovation in updating method of a value of a variable x in the line 3225, the current characteristic cycle can be longer, and it is possible to hide that they are simple data transfer processings.

Here, since the variable x is a judgment value used for sorting of processings by the switch-sentence in line 3214, it is preferable to be a seemingly random value, and if it is possible to update it in line 3225 so that it has no seeming regularity, or weak regularity, “any data whose value is determined at the time point” can be used. As a method of updating the judgment value, for example, following methods are considered.
(a) Prepare a table of judgment value separately. Or use something equivalent to table.
(b) Use a value of register and the like set at the time point.

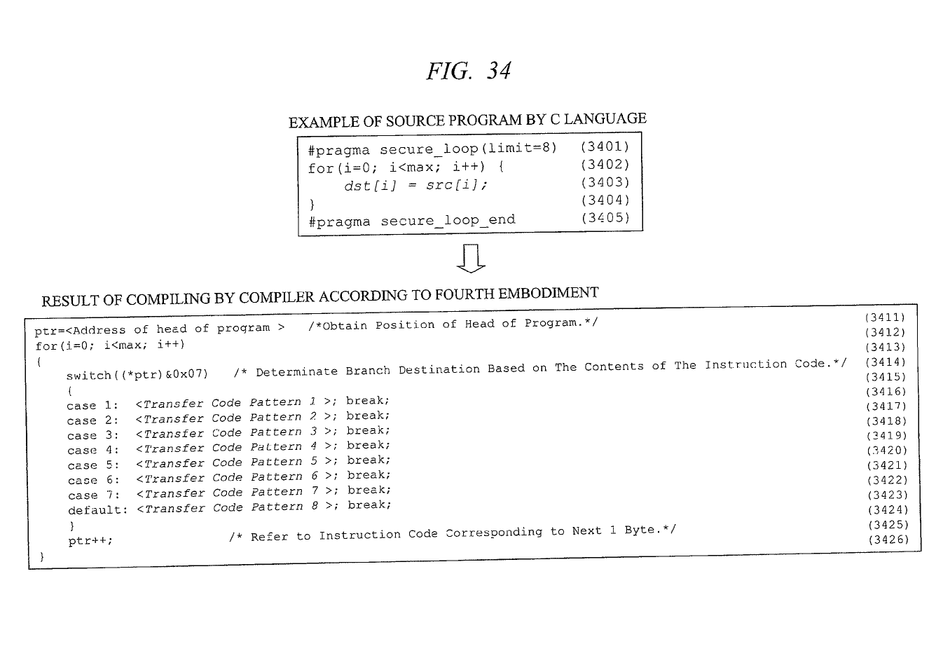

Hereinafter, examples in which a loop processing is made complicated by updating the judgment value using the updating methods of the above (a), (b) are explained. FIG. 34 shows an example in which the loop processing is complicated by updating the judgment value using a table of judgment value or something equivalent thereto described in the above (a), in an image of a C language source program.

Here, in the sorting processing, it is simplest to actually use a table of judgment value, but if the table is stored in a memory, memory use efficiency is deteriorated. In sorting, there is no need to actually prepare the table of judgment value, but as one equivalent to the table, for example, using the instruction code itself of the executable program 107 stored in a program storage area 302 of target microcomputer 208 as an element for judging, it is possible to sort processings without a cycle of a current characteristic. In a compile result in FIG. 34, values of instruction code of the executable program 107 is referred sequentially in line 3425, and in line 3414, a value from 0 to 7 are calculated using the value, and processings are sorted by a switch-sentence.

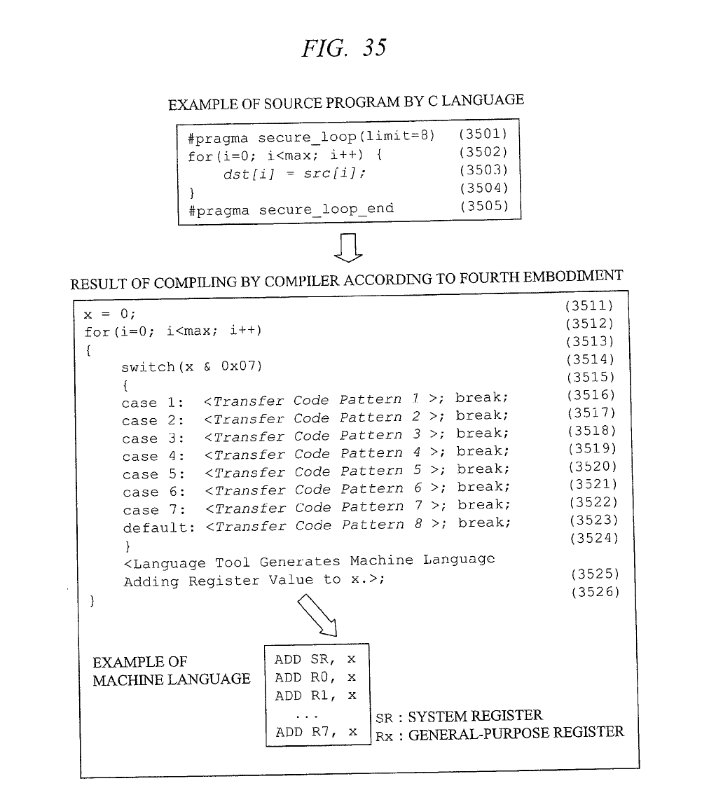

FIG. 35 shows an example of a case in which the loop processing is complicated by updating the judgment value using a set value of a register described in the above (b), in an image of a C language source program. In a compile result in FIG. 35, a value of a register at the time point of execution is obtained in line 3525, and a value from 0 to 7 is calculated using a value in line 3514, and the processings are sorted by a switch-sentence, and thereby, regularity of a current characteristic of the loop processing is eliminated. Note that, a register to be referred in line 3525 may be any register including a general purpose register and a system register and the like.

The method of updating the judgment values is not limited to the above, and various methods can be considered besides this. For example, a method in which the judgment value is updated by a calculation formula which makes the cycle of regularity of the judgment value large, and the like.

Note that, in the language tool 108 according to the present embodiment, as the method of designating a loop processing to be objective of the tamper-resistant code insertion processing in the source program 106, the method to designate for each loop processing by the extended language specification #pragma shown in FIG. 33 is employed, but in the same manner as in the first embodiment, the method to designate collectively by compile option added to a compiler start command may be employed, too.

And, similarly to the first embodiment, in an optimization processing at step 407 in FIG. 4, with regard to the intermediate representation 109 inserted by the tamper-resistant code insertion processing, it is set not to be deleted or deformed as a redundant instruction, and an inserted tamper-resistant code is set to be kept also in an optimization processing.

As explained above, by the language tool 108 according to the present embodiment, it is possible to generate a program having tamper-resistance, that is, making it difficult to presume and analyze a processing content by analysis of consumption current, by diluting regularity of a current characteristic at execution by expanding a simple loop processing by plural processing patterns and making them complicated. And, such a program that can be hardly generated manually by a user can be generated automatically, and therefore, development productivity of a program having tamper-resistance is improved. Furthermore, by executing compile by the language tool 108 according to the present embodiment, it becomes easy to port an existing source program described in high-level language into a secure program having tamper-resistance directly.

### Fifth Embodiment

Hereinafter, as a fifth embodiment, an example of a language tool generating a machine language diluting a feature of a current characteristic at execution, by approximating the current characteristic by equalizing execution time of respective branch routes of a conditional branch is explained.

In a case where a conditional branch (an if-sentence, a switch-sentence and the like in C language) exists in the source program 106, and two types of branch routes, for example, a processing A and a processing B exist in a processing of a branch destination, if execution time differs in the processing A and the processing B, there is a risk that it may be presumed “which process is carried out” from a current characteristic at execution. In particular, in a case where the processings are sorted according to kinds of confidential information, the risk is higher.

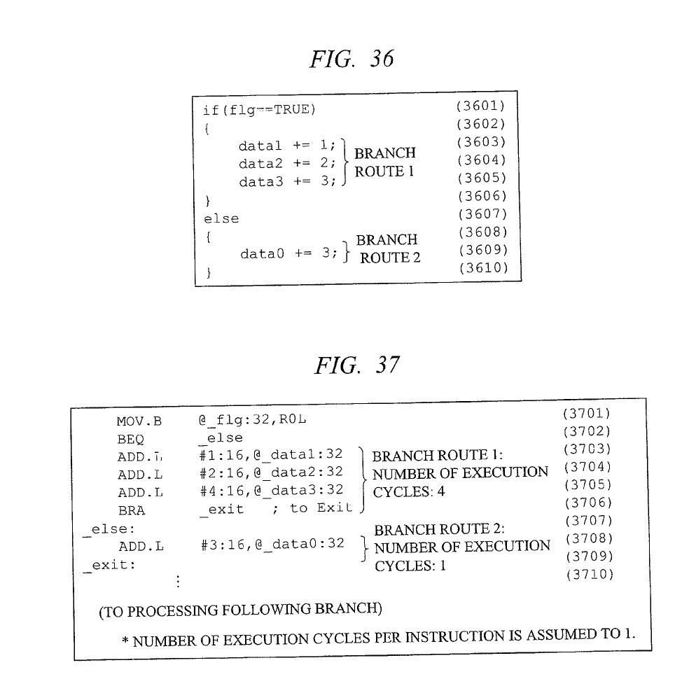

FIG. 36 shows an example of a source program in C language describing a conditional branch processing, and has a branch route 1 carrying out three data transfer processings and a branch route 2 carrying out one data transfer processing. Here, explanations are made on supposition that the number of execution cycle for one instruction is 1, for example. FIG. 37 shows an example of a machine language instruction sequence obtained as a result of compiling the source program in FIG. 36 by the conventional language tool, described in assembly description. In FIG. 37, the number of execution cycles of the branch route 1 is 4, and the number of execution cycle of the branch route 2 is 1. Since processing execution time differs in the branch routes, a risk that the processing content may be presumed exists.

And therefore, in the language tool according to the present embodiment, by embedding a processing having no effect upon an operation content of the executable program and the like, an instruction sequence of machine language is generated so that execution time of processings of respective branch routes are equalized. And thereby, in execution of an executable program, since respective processing execution time of branch routes are approximately equal and current characteristics becomes approximately equal, it is possible to make difficult for attackers to perform unjust operation analysis.

Such an instruction sequence of machine language can be prepared manually by a user. But since it requires knowledge of low-level language, a technical barrier exists and many man-hours are required. So, by adding a function equalizing execution time of processings of respective branch route to the language tool, such an instruction sequence of machine language is automatically generated. In this generation, execution time of branch route is calculated by the number of execution cycles of respective instructions in the branch route. The language tool memorizes the number of execution cycles of respective instructions, and automatically generates an instruction sequence so that totals of the number of execution cycles of instructions in respective branch routes become the same (or become as close as possible).

Hereinafter, concrete contents of the language tool according to the present embodiment are explained. A configuration diagram showing an example of an information processing device on which the language tool according to the present embodiment operates is the same as FIG. 1. And, examples of structure and a processing outline of the language tool 108 according to the present embodiment are the same as FIG. 2. Furthermore, a configuration diagram showing an example of a target microcomputer 208 in which an executable program 107 generated by the language tool 108 according to the present embodiment operates is the same as FIG. 3. And, an example of a processing flow in a compiler 201 according to the present embodiment is the same as FIG. 4.

How the execution time of a conditional branch processing in the source program 106 is equalized by the tamper-resistant code insertion processing at step 405 in FIG. 4 is explained using a simple example. Note that, here, it is supposed that the numbers of execution cycles of respective instructions are the same for making explanations simple.

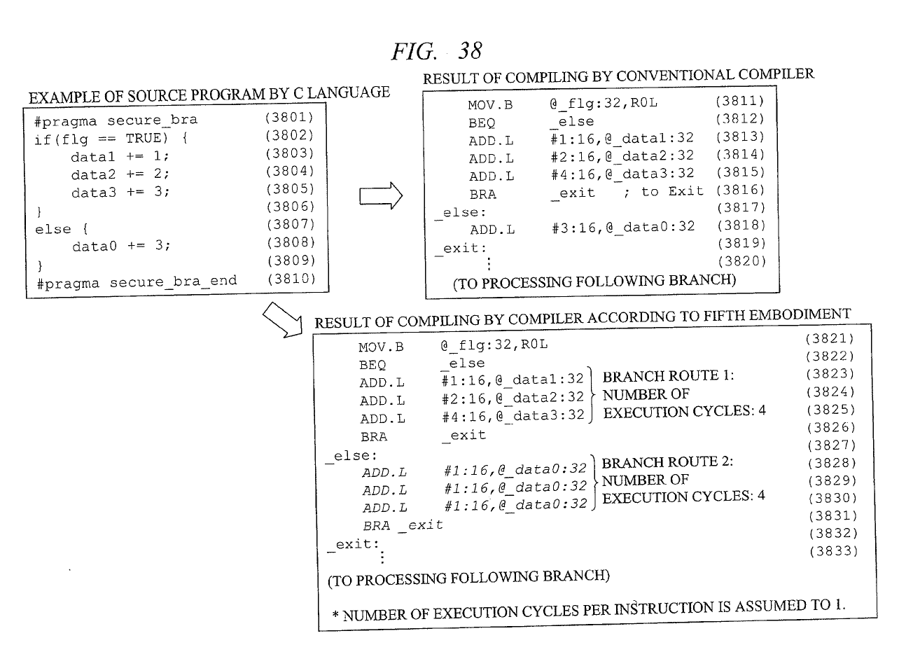

FIG. 38 shows an example of the source program 106 describing a conditional branch processing by C language, an example of a result of compiling the source program 106 by the conventional compiler, and an example of a result of compiling it by a compiler 201 according to the present embodiment. In the diagram, a portion described in italic type shows an instruction sequence generated by the tamper-resistant code insertion processing of the compiler 201 according to the present embodiment. Note that, here, explanations are made on supposition that the number of execution cycle for one instruction is 1, for example.

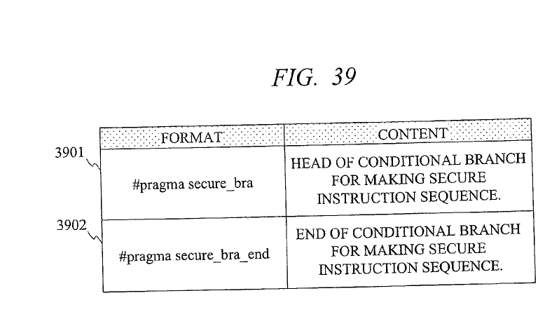

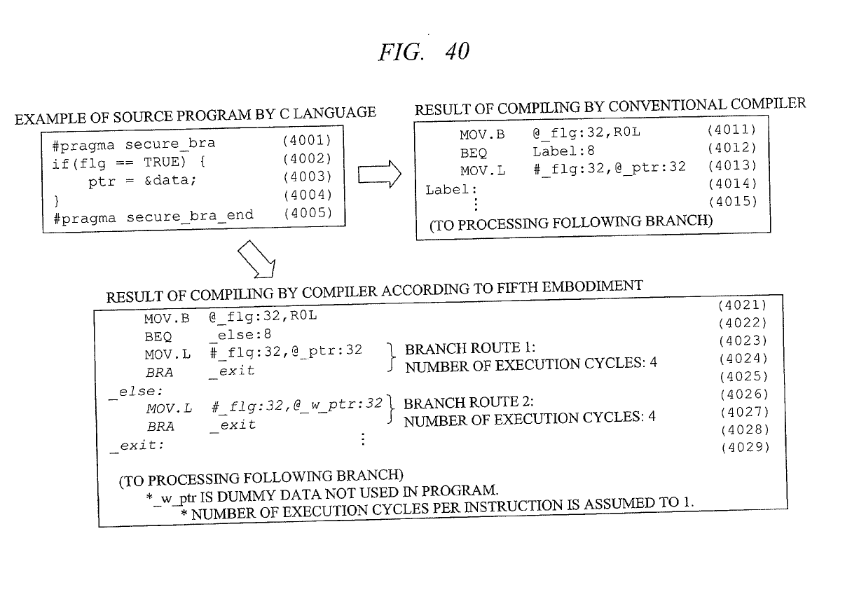

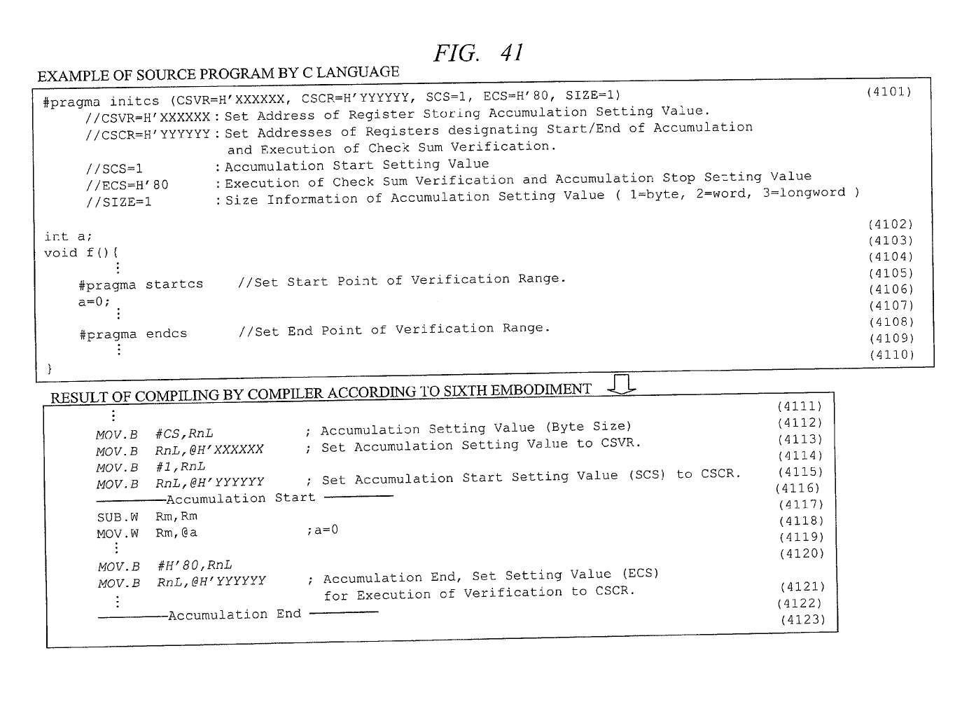

Line 3802 to line 3809 of the source program 106 show an example of the conditional branch processing. In a case where the conditional branch processing is a conditional branch whose processing content should not be known by others, in the same manner as in the fourth embodiment, a user can designate the conditional branch processing as an objective range of the tamper-resistant code insertion processing, by extended language specification #pragma of line 3801 and line 3810. FIG. 39 shows an example of a format by the extended language specification #pragma in a case where the source program 106 is described in C language.

In FIG. 38, in a result of compile by the compiler 201 according to the present embodiment, as shown in line 3828 to line 3831, an addition processing in line 3808 of an else-clause of the source program 106 is realized as 3 addition processings in the same manner as line 3823 to line 3826 which is a compile result of addition processings of line 3803 to line 3805, which is corresponding branch route, and an instruction sequence is generated so that totals of the number of execution cycles of both branch routes are 4 cycles equally. Here, the processing of “adding 3” in line 3808 and the processing of “adding 1” in three times in line 3828 to line 3830 are the same as a definitive operation content.

And, in a case where an objective conditional branch processing is an if-sentence not having an else-clause, by adding an else-clause that carries out the same processing as a processing in a conditional branch destination to dummy data not used, the same content as above can be realized easily. FIG. 40 shows an example of the source program 106 describing an if-sentence not having an else-clause in C language, an example of a result of compiling the source program 106 by the conventional compiler, and an example of a result of compiling it by the compiler 201 according to the present embodiment. In the figure, a portion described in italic type shows an instruction sequence generated by the tamper-resistant code insertion processing of the compiler 201 according to the present embodiment.

In FIG. 40, in the compile result by the compiler 201 according to the present embodiment, an else-clause starting from line 4025 is added, and in the else-clause, in line 4026, a data setting processing which is the same as a data setting processing in line 4023 in corresponding branch route is carried out to dummy data not used, and an instruction sequence is generated so that totals of numbers of execution cycles of both branch routes are 2 cycles equally. Note that, here, explanations are made on supposition that the number of execution cycle for one instruction is 1, for example.

In the present embodiment, the conditional branch processing having two branch routes by if- to else-sentences are explained as an example, but in a case where two or more branch routes exist in the source program 106 by, for example, if- to else if-sentences or switch-sentence, the same processing as the above can be carried out.

Note that, in the language tool 108 according to the present embodiment, as a method of designating a conditional branch processing to be an objective of the tamper-resistant code insertion processing in the source program 106, a method to designate each conditional branch processing by extended language specification #pragma shown in FIG. 39 is taken, but in the same manner as in the fourth embodiment, the method to designate collectively by compile option added to a compiler start command may be employed, too.

Further, in the same manner as in the first embodiment, in an optimization processing at step 407 in FIG. 4, with regard to an instruction of the intermediate representation 109 inserted by the tamper-resistant code insertion processing, it is set not to be deleted or deformed as a redundant instruction, and an inserted tamper-resistant code is set to be kept also in an optimization processing.

As described above, by the language tool 108 according to the present embodiment, a program having tamper-resistance, such as making it difficult to presume and analyze a processing content by analysis of consumption current by equalizing current characteristics at execution by adding redundant instruction to a conditional branch processing and equalizing execution time of the respective conditional branch processings can be generated. Further, such a program that can be hardly generated manually by a user can be generated automatically, and therefore, development productivity of a program having tamper-resistance is improved. Furthermore, by executing compile by the language tool 108 according to the present embodiment, it becomes easy to port an existing source program described in high-level language into a secure program having tamper-resistance directly.

### Sixth Embodiment

Hereinafter, as a sixth embodiment, an example of a language tool generating a machine language enabling detection and prevention of malfunction of a program by calculating an expected value of check sum obtained by accumulating instruction codes and comparing it with an accumulated value of instruction codes at execution by hardware.

At execution of a program, an accumulated value (check sum) of instruction codes in a predetermined area in the source program is calculated and compared with its expected value using hardware. When it is different from the expected value, it is presumed that change of instruction code or skip of instruction code occurred, and therefore, malfunction of a program can be detected or prevented.

In such verification by check sum, a method in which instruction codes of predetermined area is accumulated from 0, and the obtained value is compared with an expected value preset, and a method in which an initial value of accumulation is set so that the accumulation result becomes a specified value (for example 0), and it is confirmed that the accumulation result becomes the specified value are considered. Hereinafter, the expected value and the initial value are referred to totally as accumulation set values.

In order to perform verification by check sum, it is necessary to embed an instruction sequence setting register information of hardware for check sum verification and instructing start and end of accumulation in predetermined area to hardware into a program. Such an instruction sequence of machine language can be generated manually by a user, but it requires knowledge of low-level languages, and therefore, a technical barrier exists and many man-hours are required.

Further, the accumulation set value described above must be set preliminarily in a register or the like. Here, with regard to calculation of the accumulation set value, a method in which a user calculates it manually, a method in which it is calculated and memorized at first execution of a program, and the memorized value is used at second execution and after can be considered. However, in the method in which a user calculates it manually, man-hours of development increase largely. Further, in the method in which it is calculated at first execution of the program, verification by check sum cannot be performed in the first execution.

And therefore, by adding a function generating an instruction sequence setting register information of hardware for check sum verification and instructing start and end of the accumulation of the check sum of predetermined area and execution of verification to hardware and a function calculating accumulation set values of the predetermined area to the language tool 108, an instruction sequence of machine language realizing check sum verification is generated automatically.

Hereinafter, concrete contents of the language tool according to the present embodiment are explained. A configuration diagram showing an example of an information processing device on which the language tool according to the present embodiment operates is the same as FIG. 1. And, examples of structure and a processing outline of the language tool 108 according to the present embodiment are the same as FIG. 2. Furthermore, a configuration diagram showing an example of a target microcomputer 208 in which an executable program 107 generated by the language tool 108 according to the present embodiment operates is the same as FIG. 3. And, an example of a processing flow in a compiler 201 according to the present embodiment is the same as FIG. 4.

How the instruction sequence enabling to perform check sum verification are generated by the tamper-resistant code insertion processing at step 405 in FIG. 4 is explained using a simple example. FIG. 41 shows an example of the source program 106 describing an instruction for performing the check sum verification in C language, and an example of a result of compiling the source program 106 by the compiler 201 according to the present embodiment. In the figure, a portion described in italic type shows an instruction sequence generated by the tamper-resistant code insertion processing of the compiler 201 according to the present embodiment.

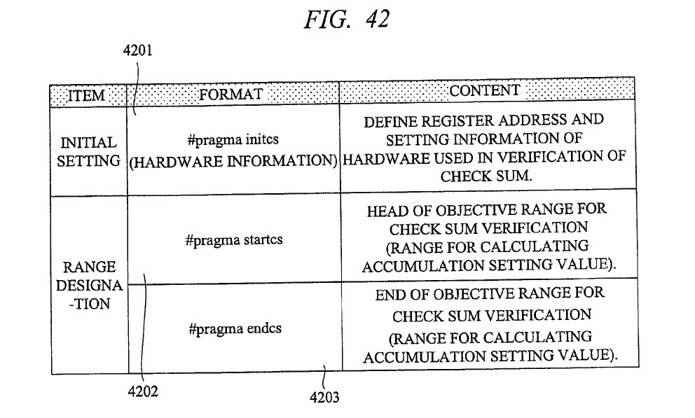

Line 4106 to line 4107 of the source program 106 show an example of a processing block in a function. In a case where a user wants to perform the check sum verification to the processing block, in the same manner as in the fourth embodiment, the user can designate the processing block as an objective range of the tamper-resistant code insertion processing, that is, an objective range of the check sum verification, by extended language specification #pragma of line 4105 and line 4108. FIG. 42 shows an example of a format by the extended language specification #pragma in a case where the source program 106 is described in C language. Using #pragma of a format 4201, addresses of registers storing the accumulation set values, a register instructing start and end of accumulation of check sum, set values thereof and the like are defined in line 4101.

In a result of compiling by the compiler 201 according to the present embodiment, with respect to a processing range in line 4117 to line 4121, accumulation set value is calculated and defined as a symbol #CS, and in line 4112 and line 4113, an instruction sequence setting the value to registers is generated. And, in line 4114, line 4115 and line 4120, line 4121, an instruction sequence setting registers for instructing hardware to start and end accumulation of check sum and execute verification is generated.

Here, in a case where a conditional branch exists in a processing, it is not clear until execution whether the instruction sequence following the conditional branch is executed or not by branch condition. And therefore, in check sum verification by hardware, at execution of conditional branch instruction, check sum verification is executed automatically in some cases. At this execution, if a range crossing conditional branch is designated as an objective range of the tamper-resistant code insertion processing, that is, an objective range of check sum verification, an error occurs at verification of check sum.

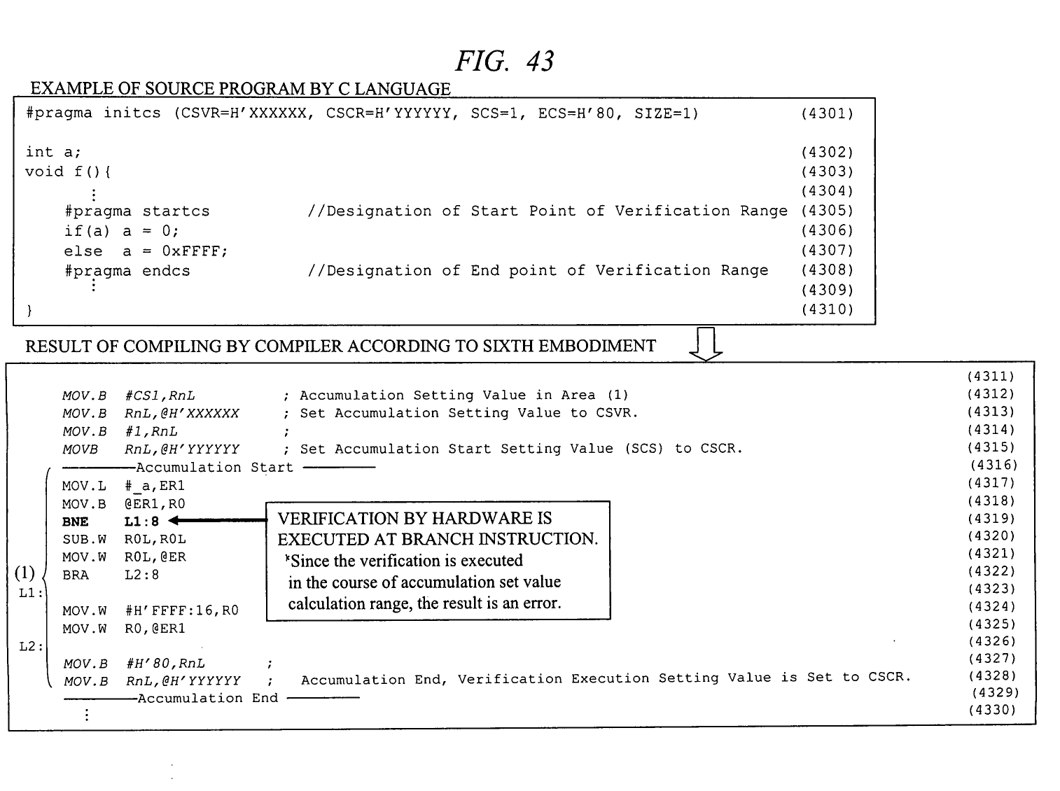

FIG. 43 shows an example of the source program 106 designating a range crossing conditional branch instructions as an objective range of the tamper-resistant code insertion processing, and an example of compiling result of the source program 106. In the figure, a portion described in italic type shows an instruction sequence generated by the tamper-resistant code insertion processing of the compiler 201 according to the present embodiment.

Line 4306 to line 4307 of the source program 106 show an example of the conditional branch processing by C language, and an if-sentence is used here, but the same is true for a for-sentence and the like. This entire conditional branch processing is designated as an objective range of the tamper-resistant code insertion processing at #pragma of line 4305 and line 4308. In this case, at execution of a program, check sum verification is carried out automatically by hardware, in a conditional branch processing (BNE) in line 4319 in compile result, and since it is verification in the way of accumulation set value calculation and the result becomes an error.

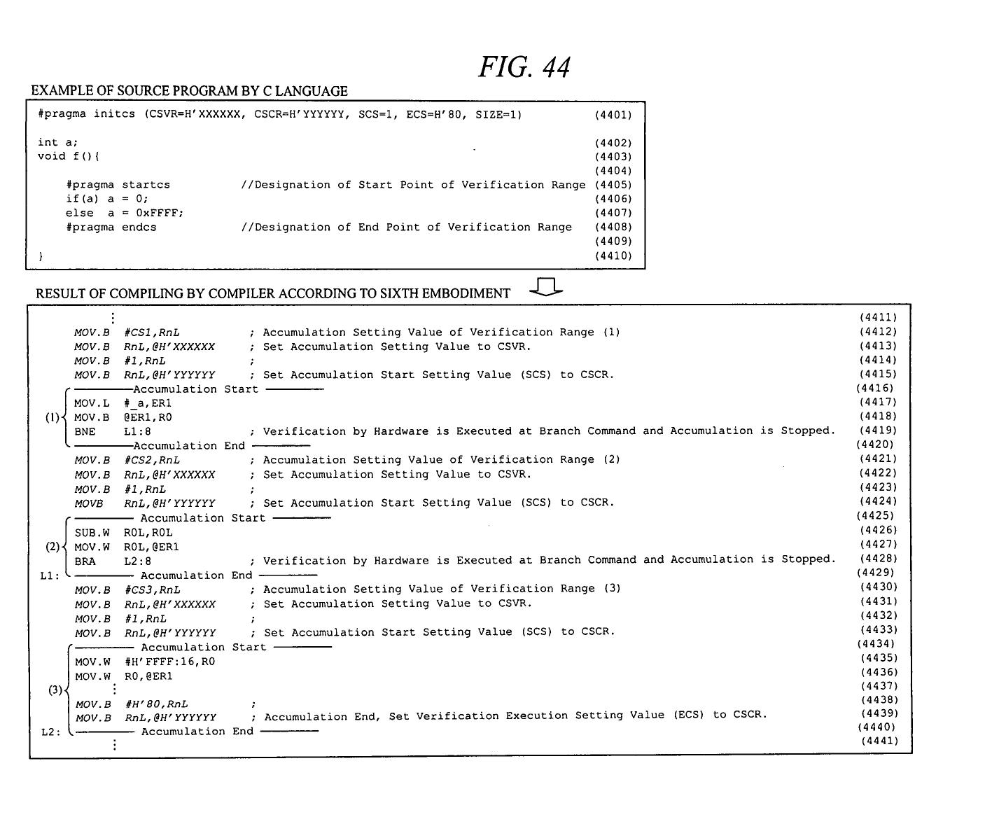

And therefore, in the compiler 201 according to the present embodiment, in order to correctly perform check sum verification even if conditional branch exists in the processing, an instruction sequence is automatically generated so that the objective range is sectioned and check sum verification is carried out, at every time when conditional branch appears in the range designated as a objective range of the tamper-resistant code insertion processing. FIG. 44 shows an example of the source program 106 designating a range crossing conditional branches as an objective range of the tamper-resistant code insertion processing, and an example of result of compiling the source program 106 by the compiler 201 according to the present embodiment. In the figure, a portion described in italic type shows an instruction sequence generated by the tamper-resistant code insertion processing of the compiler 201 according to the present embodiment.

In the compile result in FIG. 44, at appearance of branch instructions (BNE, BRA) of line 4419, line 4428, stop of accumulation and check sum verification at the time point are carried out by hardware. And therefore, the objective range of check sum verification is sectioned there, and an instruction sequence starting accumulation newly from there is generated (line 4421 to line 4424, line 4430 to line 4433). And thereby, a user can designate an objective range of the tamper-resistant code insertion processing without regarding to a conditional branch processing, and the check sum verification can be performed easily.

Note that, in the language tool 108 according to the present embodiment, as a method of designating an objective range of the tamper-resistant code insertion processing, that is, an objective range of the check sum verification, in the source program 106, a method to designate for each processing block by extended language specification #pragma shown in FIG. 42 is employed, however, in the same manner as in the first embodiment, a method to designate collectively by compile option added to a compiler start command can be employed, too.

Further, in the same manner as in the first embodiment, in the optimization processing at step 407 in FIG. 4, with regard to the intermediate representation 109 inserted by the tamper-resistant code insertion processing, it is set not to be deleted or deformed as a redundant instruction, and an inserted tamper-resistant code is set to be kept also in an optimization processing.

As described above, by the language tool 108 according to the present embodiment, a program having tamper-resistance realizing detection or prevention of malfunction in execution of the program by check sum verification, by executing hardware setting of performing the check sum verification of instruction code, instructing to start and end accumulation of instruction codes for check sum verification, calculating automatically accumulation set values of an objective range and the like by hardware can be generated. Further, such a program that can be hardly generated manually by a user can be generated automatically, and therefore, development productivity of a program having tamper-resistance is improved. And, by executing compile by the language tool 108 according to the present embodiment, it becomes easy to port an existing source program described in high-level language into a secure program having tamper-resistance directly.

### Seventh Embodiment

Hereinafter, as a seventh embodiment, an example of detecting operation error of a program by duplicating a program code is explained.

As described previously, as countermeasures against the fault based attack presuming a cryptographic key, a method in which a processing is duplicated according to encryption and calculation is performed in two times and it is confirmed that the calculation results of two times are equal and the like are proposed. The two-times calculations in this method is realized by a method in which a programmer makes the program at necessity, or calculation is performed by two or more CPUs or operating devices and it is checked whether or not the calculation results are equal at output of calculating result. It is prevailing that a programmer makes a program newly or hardware appropriate for duplicated calculations is prepared.

As a method of detecting operation error of a program using a duplication processing, in particular as a method in which structure of hardware duplicating operating system of a program is not used, realized on hardware on assumption of existing a single processing system, it is reasonable to duplicate a program to be executed. As an objective of duplication of a program, a program code is considered. Here, a program code means a source program described in program language, an intermediate representation, an assembly language program and machine language generated via a compiler.

However, detection of an operation error of a program using a duplication processing of a program code is not carried out. This is because duplication of software itself is disadvantage in program processing speed and memory use efficiency, and therefore, the method has not been considered much. Further, in a case where an operation error of a program is detected using a duplication processing, it is necessary to compare the results of the first calculation and the second calculation after execution of the duplicated program. However, variable necessary for the calculation processing may be updated during the first calculation, and in such a case, the second calculation cannot be carried out correctly, as a result, it is difficult to compare the results of the first calculation and the second calculation.

And therefore, in the present embodiment, an instruction sequence of machine language where a program code is duplicated are automatically generated, and thereby operation error of a program is detected. A tamper-resistant code insertion processing adding a function for detecting program operation error includes a first function generating a second instruction code concerning duplication of a first instruction designated preliminarily in a source program, a second function generating a comparison processing code for comparing an execution result of the first instruction and an execution result of the second instruction and a third function generating an error processing code for stopping program execution in a case where a result of the comparison processing is mismatch.

Further, the tamper-resistant code insertion processing in the present embodiment includes a fourth function generating a code for dependence analysis of relation between a variable used in the first instruction execution and another processing of the variable and a fifth function generating a code for obtaining copy of information including variable necessary for the execution of the second instruction based on an result of the analysis of the fourth function. And in the dependence processing, an analysis symbol showing depth of dependence analysis described later is used.

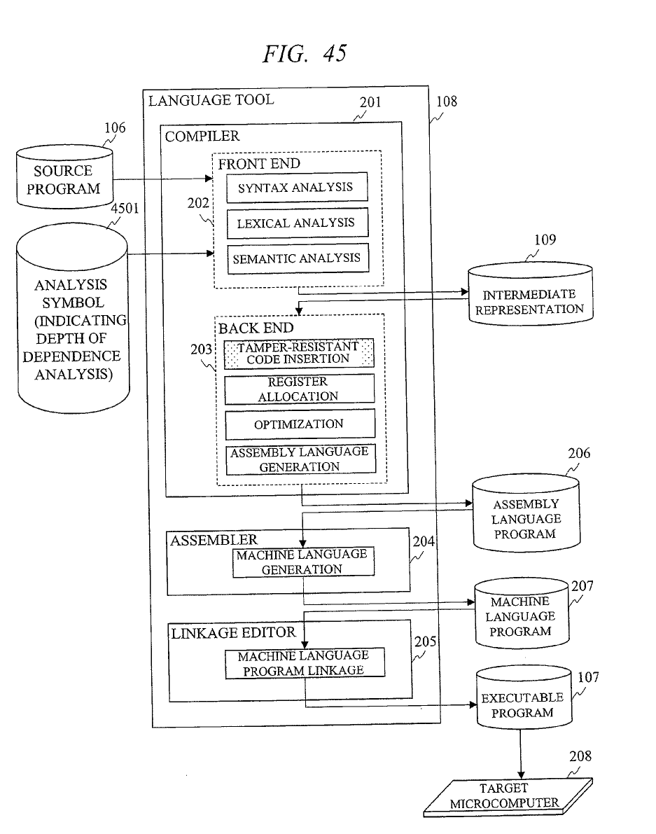

Hereinafter, concrete contents of the language tool according to the present embodiment are explained. A configuration diagram showing an example of an information processing device on which the language tool according to the present embodiment operates is the same as FIG. 1. FIG. 45 is a diagram showing examples of structure and a processing outline of the language tool 108 according to the present embodiment. In addition to the structure of the language tool 108 shown in FIG. 2, an analysis symbol 4501 is inputted together with the source program 106 as input to the language tool 108. Other structure is the same as the structure shown in FIG. 2. A configuration diagram showing an example of a target microcomputer 208 in which an executable program 107 generated by the language tool 108 according to the present embodiment operates is the same as FIG. 3. And, an example of a processing flow in a compiler 201 according to the present embodiment is the same as FIG. 4.

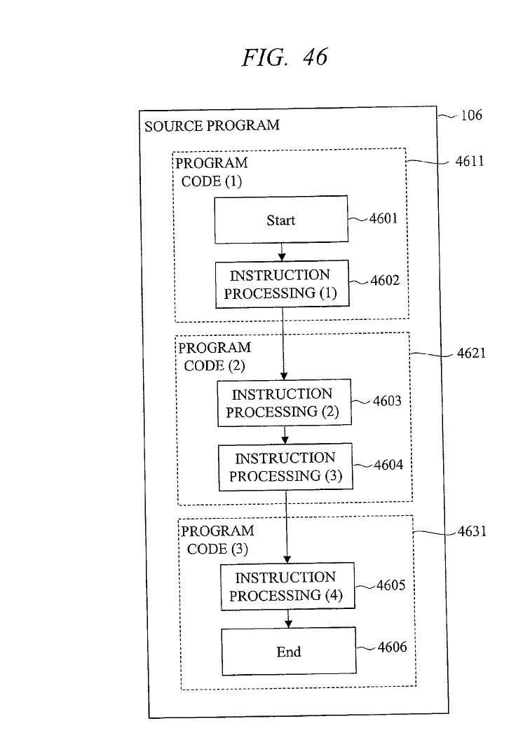

How the duplication of a program code is executed by the tamper-resistant code insertion processing at step 405 in FIG. 4 is explained using a simple example. FIG. 46 is a diagram showing an example of a processing flow in a general source program 106. Since a program code is a unit obtained by dividing a program at least using an instruction processing unit in control flow as border, start 4601 and an instruction processing (1) 4602 are defined as a program code (1) 4611 which is one of divisions, and an instruction processing (2) 4603 and an instruction processing (3) 4604 are defined as a program code (2) 4621 which is one of the divisions, and an instruction processing (4) 4605 and end 4606 are defined as a program code (3) 4631 which is one of the divisions.

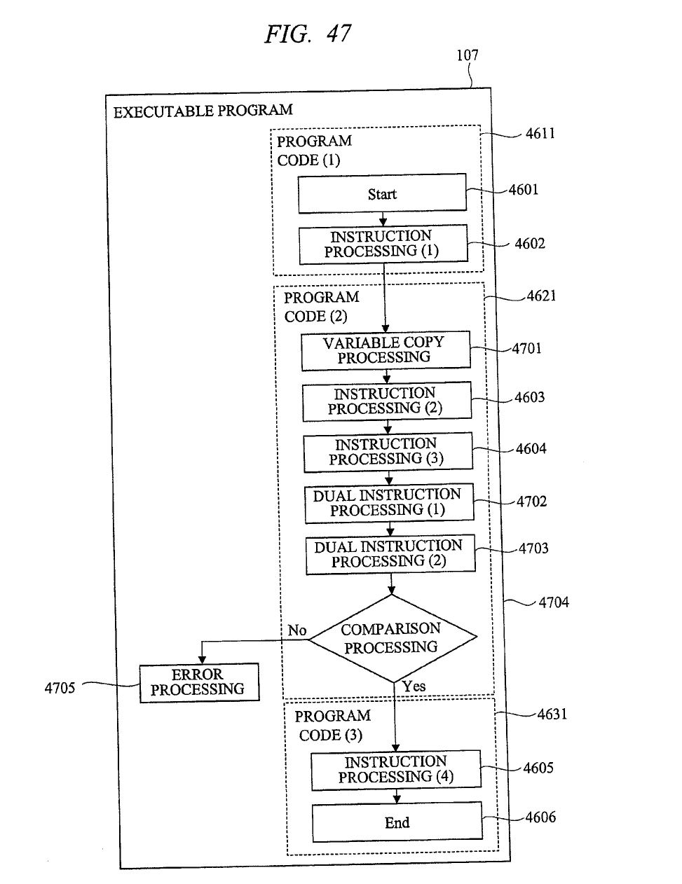

FIG. 47 is a diagram showing an example of a processing flow in the executable program 107 obtained by the language tool 108 according to the present embodiment using the source program 106 in FIG. 46 as input. In the example in FIG. 47, the program code (2) 4621 designated as an objective to be duplicated by a user is duplicated. That is, the instruction processing (2) 4603 and the instruction processing (3) 4604 are duplicated, and a dual instruction processing (1) 4702 and a dual instruction processing (2) 4703 are inserted.

Further, in the program code (2) 4621, a variable copy processing 4701 is inserted before the instruction processing (2) 4603. In the variable copy processing 4701, a variable used in the instruction processing (2) 4603 and a variable used in the instruction processing (3) 4604 are copied to storage areas different each other. For example, the variable used in the instruction processing (2) 4603 is copied to a first storage area, and the variable used in the instruction processing (3) 4604 is copied to a second storage area. By the variable copy processing 4701 described above, variable copies are obtained. Further, in this variable copy processing 4701, it is judged whether or not there is a variable rewritten in the instruction processing (2) 4603 and the instruction processing (3) 4604 from description of the instruction processing, and a flag is set to a variable to be rewritten.

And, after the variable copy processing 4701, the instruction processing (2) 4603 and the instruction processing (3) 4604 are inserted. And then, the dual instruction processing (1) 4702 which is the same as the instruction processing (2) 4603 logically or mathematically is inserted, further, the dual instruction processing (2) 4703 which is the same as the instruction processing (3) 4604 logically or mathematically is inserted. In the dual instruction processing (1) 4702, the variable copied to the first storage area is referred to, and in the dual instruction processing (2) 4703, the variable copied to the second storage area is referred to.

After the dual instruction processing (2) 4703, a comparison processing 4604 is inserted. In this comparison processing 4704, it is judged whether or not the variable with the flag has been rewritten or not, by execution of the instruction processing (2) 4603 and the dual instruction processing (1) 4702 and execution of the instruction processing (3) 4604 and the dual instruction processing (2) 4703. And, in a case where it is judged that any variable with the flag has been rewritten by the comparison processing 4704, the procedure transits to an error processing 4705 for stopping a program execution. In a case where it is judged that no variable with the flag has been rewritten by the comparison processing 4704, the procedure transits to an instruction processing (4) 4605 of the program code (3) 4631.

According to the above example, even if data of storage area is changed into unexpected value or the processing itself fails because hardware malfunction occurs in the way of the instruction processing (2) 4603 or the instruction processing (3) 4604, by execution of the dual instruction processing (1) 4702 or the dual instruction processing (2) 4703, processings outputting the same values are executed, and therefore, in the comparison processing 4704, the malfunction of the program can be detected unless the same hardware malfunction occurs in execution of the dual instruction processing (1) 4702 or the dual instruction processing (2) 4703.

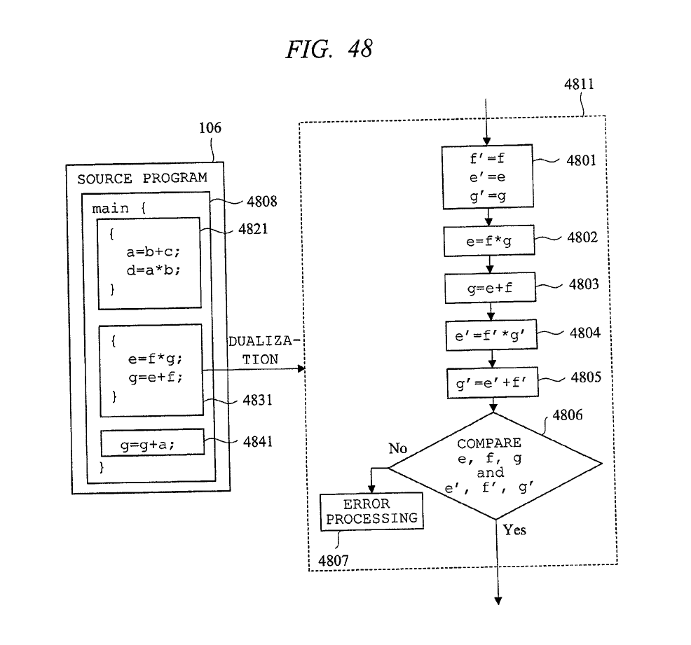

Next, the duplication processing is explained in more detail. FIG. 48 is a diagram showing a concrete example of the duplication processing. The source program 106 including program codes 4821, 4831 and 4841 is inputted to the language tool 108, and in a case where a duplication processing of the program code 4831 is designated, a variable copy processing 4801 is inserted before the instruction processing 4802 in the program code 4811.

Here, copies f′, e′, g′ of variables f, e, g are obtained. The copies e′, f′, g′ of variables e, f, g used in the instruction processing 4802 are copied to a first storage area, and the copies g′, e′, f′ of variables g, e, f used in the instruction processing 4803 are copied to a second storage area. By the dual instruction processing 4804 concerning duplication of the instruction processing 4802, an operation processing “e′ f′*g′” is carried out, and by the dual instruction processing 4805 concerning duplication of the instruction processing 4803, an operation processing “g′=e′+f′” is carried out.

In the comparison processing 4806, comparison of variables e, f, g and their copies e′, f′, g′ is carried out. Based on a result of this comparison, unless all the variables are matched, the procedure transits to the error processing 4807 for stopping a program execution.

Note that, in an instruction of a user for carrying out the duplication processing to the program code 4831, for example, a method to designate it using the extended language specification #pragma, like the language tool 108 according to the first embodiment, a method to designate it by compiler option to the compiler 201 and the like can be employed.

Further, in the same manner as in the first embodiment, in an optimization processing at step 407 in FIG. 4, with regard to the intermediate representation 109 corresponding to an instruction inserted by the tamper-resistant code insertion processing, it is set not to be deleted or deformed as a redundant instruction, and an inserted tamper-resistant code is set to be kept also in an optimization processing.

A variable used for execution of processings in the source program 106 and depth of the dependence analysis analyzing a relation between the variable and another processing can be designated by an analysis symbol 4501 inputted to the language tool 108 together with the source program 106.

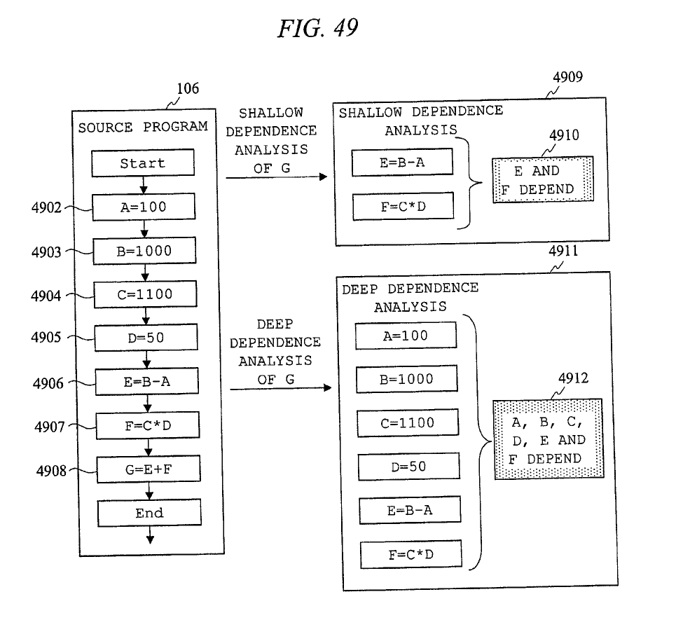

For example, as shown in FIG. 49, a case in which the source program 106 to be an objective includes instruction processings 4902 to 4908 is described. In such a case, in a case where shallow dependence analysis 4909 is designated for a variable G, a dependence range 4910 is limited to variables E, F. On the other hand, in a case where deep dependence analysis 4911 is designated for the variable G, a dependence range 4912 is expanded to variables A, B, C, D, E and F. The deeper the depth of dependence analysis is, the analysis precision becomes higher, however, since information amount increases, time required by the analysis increases. It is preferable that the depth of dependence analysis is designated appropriately according to the source program 106 to be an objective.

As described above, according to the present embodiment, following effects are obtained.

(1) According to the target microcomputer 208 executing the executable program 107 generated by the information processing device executing the language tool 108, just before execution of a program code performing the duplication processing, a variable in a storage area which the program code accesses is duplicated in other area in the storage area. In particular, by executing dependence analysis of variable in the program code, efficient duplication of variable can be realized. Using the duplicated variable, calculation by a first time program code is executed in the program code which is duplication objective, and in a second time program code, second time calculation is executed using a variable which is duplicated. Even if value or information of the variable is updated in the first time calculation, since a variable used in a second time processing is one that is duplicated in other area before the first time calculation is carried out, the second time calculation is not affected by update in the first time calculation. As a result, in the first time processing and the second time processing, the same calculation processings can be carried out. In consideration of these, by comparing variables updated in the first time calculation and the second time calculation after the first time calculation and the second time calculation are executed sequentially, malfunction that occurs in the calculation processing can be detected easily.

(2) The executable program 107 making the effect of the above (1) is automatically generated by a compile processing in the information processing device executing the language tool 108, and therefore, a programmer does not have to perform the duplication processing to the source program 106.

(3) In the variable copy processing 4701 in FIG. 47, it is judged whether or not there is any variable rewritten by the instruction processing (2) 4603 and the instruction processing (3) 4604 from description of the instruction processing, and flag is set to a variable to be rewritten. And, in the comparison processing 4704, it is judged whether the variable with the flag has been rewritten or not, by execution of the instruction processing (2) 4603 and the dual instruction processing (1) 4702 and execution of the instruction processing (3) 4604 and the dual instruction processing (2) 4703. Thus, in the comparison processing 4704, only a variable with the flag set is a comparison objective, and therefore, in comparison with a case in which the comparison processing is performed to all variables, necessary processing can be completed in shorter time.

### Eighth Embodiment

As an eighth embodiment, another example of configuration detecting operation error of a program by duplicating a program code is explained.

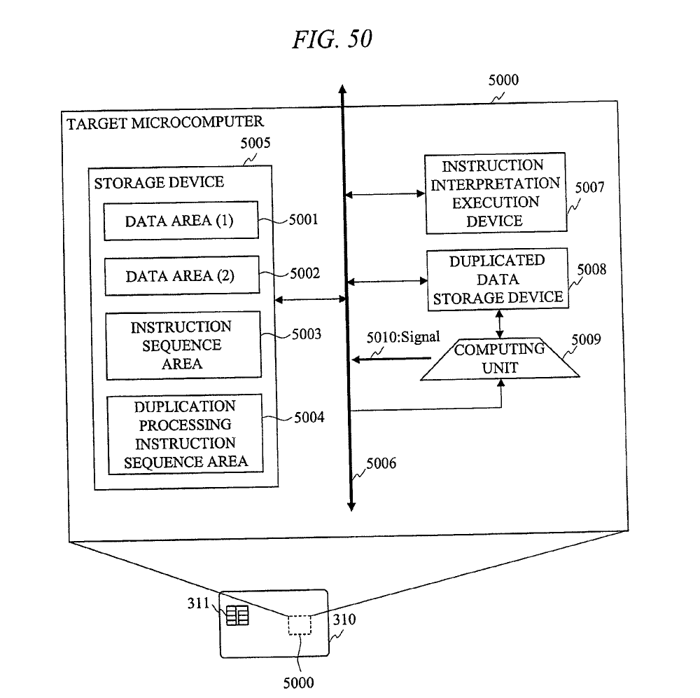

A target microcomputer 5000 shown in FIG. 50 is, although not limited specifically, a microcomputer for IC card loaded in IC card 310, and although not limited specifically, it includes a storage device 5005, an instruction interpretation execution device 5007, a duplicated data storage device 5008 and a computing unit 5009, and these are connected by a bus 5006 so that a signal can be transmitted therebetween. And, the target microcomputer 5000 is, although not limited specifically, formed on a semiconductor substrate such as a single crystal silicon substrate and the like, by known semiconductor integrated circuit manufacture technology.

In the above storage device 5005, a data area (1) 5001, a data area (2) 5002, an instruction sequence area 5003, and a duplication processing instruction sequence area 5004 are formed. An instruction sequence in which a program operation error is to be detected is stored in the instruction sequence area 5003 in the storage device 5005. In part of the instruction sequence in the instruction sequence area 5003, a mark indicating an instruction sequence in which a program operation error is to be detected is attached. Using this mark as a trigger, the instruction duplication processing is executed.

The instruction interpretation execution device 5007 is so-called CPU, and fetches instructions of the instruction sequence area 5003 via the bus 5006 sequentially, interprets the instructions, and executes them. An execution result of the instructions is stored in the data area (1) 5001. At this moment, the data area (1) 5001 not only stores the result, but also is used for data reference by the instruction interpretation execution device 5007.

In a case where an instruction with the mark indicating that the instruction is an instruction in which a program operation error is to be detected is fetched, the procedure transits to execution of the duplication processing instruction sequence in the duplication processing instruction area 5004 before execution of the instruction. The instruction interpretation execution device 5007, in accordance with the above duplication processing instruction sequence, reads the instruction to be duplicated from the instruction sequence area 5003, copies data in the data area (1) 5001 used in execution of the instruction to the data area (2) 5002, and thereafter, executes the instruction with the mark indicating that a program operation error is to be detected in the instruction (an instruction fetched beforehand). At this moment, the instruction interpretation execution device 5007 refers to data in the data area (1) 5001 in some cases.

An execution result of the instruction with the mark indicating that the instruction is an instruction in which a program operation error is to be detected is written to the duplicated data storage device 5008. And thereafter, the instruction interpretation execution device 5007 executes an instruction which is the same as or equivalent to the instruction with the mark. As a result, the instruction with the mark is executed in plural times. At this moment, the instruction interpretation execution device 5007 refers not to the data area (1) 5001, but to the data area (2) 5002, in a case where data to be referred to exists. And an execution result of the instruction equivalent to the instruction with the mark is written into not-used area in the duplicated data storage device 5008.

And thereafter, the instruction interpretation execution device 5007 controls operation of the computing unit 5009, and compares two execution results of instruction in the duplicated data storage device 5008. In a case where the results are mismatch, the computing unit 5009 asserts a control signal 5010. And thereby, the instruction interpretation execution device 5007 is transited to an error processing for stopping the program execution. By executing the error processing, the program execution after that is stopped. And, in a case where two execution results of instruction in the duplicated data storage device 5008 match, next instruction is fetched from the instruction sequence area 5003. And, in a case where an instruction without the mark is fetched, the above duplication processing by the instruction interpretation execution device 5007 is not carried out.

According to the above structure, in the instruction sequence in the instruction sequence area 5003, only the mark indicating the instruction in which a program operation error is to be detected has to be added, and therefore, as in the case shown in FIG. 45 to FIG. 49, in the language tool 108, a processing adding a function for program operation error detection to the source program 106, the intermediate representation and the like is not required. In other words, by adding the mark to an instruction sequence of an existing executable program 107, a program operation error can be detected using the duplication processing of a program code, without recompilation or the like.

Further, for example, in the structure shown in FIG. 50, the mark indicating an instruction sequence in which program operation error detection is to be performed is attached to a part of an instruction sequence in the instruction sequence area 5003, and using this mark as a trigger, the instruction duplication processing is carried out, meanwhile, data for determining timing of the duplication processing may be stored in the storage device 5005, and based on the data, the duplication processing may be carried out at the corresponding timing. In such a case, the mark indicating an instruction sequence in which program operation error detection is to be performed does not have to be attached to a part of an instruction sequence in the instruction sequence area 5003.

In the respective embodiments explained above, the target microcomputers 208, 5000 can be applied to others than an IC card. And, the tamper-resistant code insertion processing in the language tool 108 can be used in arbitrary combination as shown in the example shown in FIG. 20.

And, in the explanations heretofore, the invention made by the present inventors has been explained mainly with a case in which it is applied to the language tool 108 having the compiler 201 which is the field of the invention to be background of the invention, however, the present invention is not limited to this. At least, the present invention can be applied on a condition that the source program 106 is converted into the executable program 107, and can be applied widely to a format conversion program for realizing a processing for converting the source program 106 into the executable program 107 by computer.

In the foregoing, the invention made by the inventors of the present invention has been concretely described based on the embodiments. However, it is needless to say that the present invention is not limited to the foregoing embodiments and various modifications and alterations can be made within the scope of the present invention.

The method of generating a program according to the present invention can be used for a method of generating a secure program having tamper-resistance loaded in an information processing device such as an IC card and the like and embedded system. Further, it can be used to a microcomputer for security application such as an IC card loading the program and the like.

What is claimed is:

1. A method of generating a program making an executable program by reading a source program described in programming language by a computer,
wherein the computer executes: a syntax analysis step of reading the source program and performing syntax analysis; an intermediate representation generation step of generating an intermediate representation from the source program; a register allocation step of allocating a register to the intermediate representation; an optimization processing step of performing an optimization processing to the intermediate representation; an assembly language generation step of generating an assembly language program from the intermediate representation; a machine language generation step of generating a machine language program from the assembly language program; and a machine language program linkage step of linking the machine language program and another machine language program and generating an executable program, and
wherein a tamper-resistant code insertion step of automatically generating a code having tamper-resistance coping with unjust analysis of an operation content of the executable program is executed to the source program, the intermediate representation, the assembly language program or the machine language program based on an instruction of a user, between finish of reading of the source program and generation of the executable program.

2. The method of generating program according to claim 1,
wherein the code having tamper-resistance generated in the tamper-resistant code insertion step is a code enabling detection or prevention of malfunction at execution of the executable program with respect to a multiplex conditional branch processing in the source program by holding information for checking on a register or a memory whether or not a judgment processing of each conditional branch is passed correctly and checking whether or not the information is an appropriate value in processing in each destination of the conditional branch.

3. The method of generating program according to claim 1,
wherein the code having tamper-resistance generated in the tamper-resistant code insertion step is a code enabling detection or prevention of malfunction at execution of the executable program with respect to a conditional branch processing in the source program by multiplexing a judgment processing at a conditional branch into double or more.

4. The method of generating program according to claim 1,
wherein the code having tamper-resistance generated in the tamper-resistant code insertion step is a code enabling detection or prevention of malfunction at execution of the executable program with respect to a function call processing in the source program by setting on a register or a memory a value for checking calculated by a predetermined procedure from an argument to be delivered to a function of call destination in a function calling side; and checking validity of the argument by comparing a value calculated by the predetermined procedure from the delivered argument and the value for checking in a function called side.

5. The method of generating program according to claim 1,
wherein the code having tamper-resistance generated in the tamper-resistant code insertion step is a code diluting a feature of a current characteristic at execution of the executable program with respect to a loop processing in the source program by generating an instruction sequence of plural patterns having a same processing content.

6. The method of generating program according to claim 1,
wherein the code having tamper-resistance generated in the tamper-resistant code insertion step is a code diluting a feature of a current characteristic at execution of the executable program with respect to a conditional branch processing in the source program by generating an instruction sequence equalizing execution time of respective conditional branch routes.

7. The method of generating program according to claim 1,
wherein the code having tamper-resistance generated in the tamper-resistant code insertion step is a code enabling detection or prevention of malfunction at execution of the executable program with respect to a processing range designated by the user in the source program by generating an instruction sequence calculating an expected value of a check sum obtained by accumulating an instruction code in the processing range, setting hardware for performing verification by the check sum and instructing the hardware to start and end the accumulation of instruction code and execute the verification by the check sum.

8. The method of generating program according to claim 1,
wherein the tamper-resistant code insertion step generates a second instruction code concerning duplication of a first instruction designated preliminarily in the source program, a comparison processing code for comparing an execution result of the first instruction and an execution result of the second instruction and a code for executing a predetermined error processing when a result of the comparison processing is mismatch as codes for detecting a program operation error.

9. The method of generating program according to claim 8,
wherein the tamper-resistant code insertion step further generates a code for dependence analysis of relation between a variable used in the execution of the first instruction and another processing using the variable, a code for obtaining a copy of information including a variable necessary for execution of the second instruction based on a result of the dependence analysis and a code for executing the second instruction using the copy of information including the variable.

10. The method of generating program according to claim 9,
wherein depth of the dependence analysis can be designated by the user.

11. An information processing device comprising:
a CPU capable of executing a first processing of converting a source program described in programming language into an executable program and a second processing of adding a function for detecting a program operation error before converting the source program into the executable program,
wherein the second processing generates a second instruction code concerning duplication of a first instruction designated preliminarily in the source program, a comparison processing code for comparing an execution result of the first instruction and an execution result of the second instruction and a code for executing a predetermined error processing when a result of the comparison processing is mismatch.

12. The information processing device according to claim 11,
wherein the second processing further generates a code for dependence analysis of relation between a variable used in the execution of the first instruction and another processing using the variable, a code for obtaining a copy of information including a variable necessary for the execution of the second instruction based on a result of the dependence analysis and a code for executing the second instruction using the copy of information including the variable.

13. The information processing device according to claim 12,
wherein depth of the dependence analysis can be designated by a user.

14. A microcomputer including an instruction interpretation execution device capable of interpreting and executing a program, comprising:
a duplicated data storage device to which results of executions in plural times of a predetermined instruction included in the program by the instruction interpretation execution device are written; and
a computing unit comparing the results of the execution in plural times by the instruction interpretation execution device based on data in the duplicated data storage device and generating a signal for stopping operation of the instruction interpretation execution device when a result of the comparison is mismatch.

15. The microcomputer according to claim 14,
wherein a variable used in the execution in plural times of the predetermined instruction in the program by the instruction interpretation execution device are copied before the predetermined instruction is executed by the instruction interpretation execution device.

16. A microcomputer comprising:
a memory storing an executable program, cryptographic key data and confidential information;
a CPU capable of interpreting and executing the executable program;
an input/output unit controlling input/output with outside; and
a bus connecting the memory, the CPU and the input/output unit,
wherein the confidential information is exchanged through encryption and decryption processings using the cryptographic key data so that the confidential information stored in the memory is not referred and rewritten unjustly, and
wherein the executable program stored in the memory is an executable program generated by the method of generating a program according to claim 1.
